(19) United States
(12) Patent Application Publication
(10) Pub. No.: US 2020/0196601 A1
(43) Pub. Date: Jun. 25, 2020

(54) HERBICIDE SAFENER COMPOSITIONS CONTAINING QUINAZOLINEDIONE-6CARBONYL DERIVATIVES

(71) Applicant: Bayer CropScience Aktiengesellschaft, Monheim am Rhein (DE)

(72) Inventors: Ralf BRAUN, Ramberg (DE); Christian WALDRAFF, Bad Vilbel (DE); Jan DITTGEN, Frankfurt (DE); Christopher Hugh ROSINGER, Hofheim (DE)

(21) Appl. No.: 16/610,043

(22) PCT Filed: Apr. 26, 2018
(86) PCT No.: PCT/EP2018/060746

§ 371 Date: Oct. 31, 2019

(30) Foreign Application Priority Data
May 4, 2017 (EP) 17169503.4

(51) Int. Cl. A01N 43/54; A01N 43/56; A01N 43/82; A01N 43/80; A01N 43/42; A01N 43/76; A01N 41/06; A01N 43/28

(52) U.S. Cl. CPC A01N 43/54; A01N 43/56; A01N 43/82; A01N 43/28; A01N 43/42; A01N 43/76; A01N 41/06; A01N 43/80

(57) ABSTRACT

What are described are herbicide safener compositions comprising active herbicidal compounds from the group of the quinazolinedione-6-carbonyl derivatives of the formula (I) and safeners. In formula (I), Q represents a heterocyclic radical. Z represents a chalcogen atom. R¹, R² and W represent radicals such as hydrogen and organic radicals. Suitable safeners are, for example, mefenpyr-diethyl, cyprosulfamide and isoxadifen-ethyl.

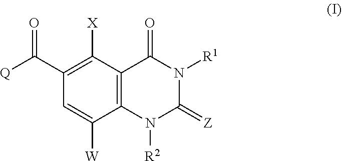

These herbicide safener compositions are particularly suitable for use against harmful plants in crops of useful plants.

The present invention relates to agrochemically active herbicide safener compositions, to processes for production thereof and to the use thereof for control of harmful plants.

WO 2015/058519 A1 discloses that certain 6-(cyclohexanedionecarbonyl)-quinazolinediones have herbicidal properties. WO 2017/140612 A1 discloses quinazolinedione-6-carbonyl derivatives having herbicidal properties. However, not all of these active compounds are fully compatible with important crop plants, such as cereal species, corn or rice. Therefore, they cannot be used in some crops in such a way as to assure the desired broad herbicidal efficacy against harmful plants.

It is therefore an object of the present invention to provide herbicidal compositions in which the selectivity of the abovementioned herbicides with respect to important crop plants is increased. This object is achieved by the herbicide safener compositions according to the invention, described hereinafter, comprising herbicides and safeners.

The present invention provides herbicide safener compositions comprising

(A) one or more herbicidally active compounds of the formula (I) or salts thereof,

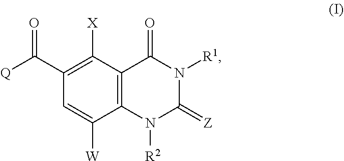

in which
X represents nitro, halogen, cyano, formyl, thiocyanato, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cycloalkyl, (C₃-C₆)-halocycloalkyl, (C₃-C₆)-cycloalkyl-(C₁-C₆)-alkyl, (C₃-C₆)-halocycloalkyl-(C₁-C₆)-alkyl, COR¹, OR¹, OCOR¹, OSO₂R², S(O)ₙR², SO₂OR¹, SO₂N(R¹)₂, NR¹SO₂R², NR¹COR¹, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R² or NR¹R²,
Z represents O or S,
W represents hydrogen, nitro, halogen, cyano, (C₁-C₄)-alkyl, (C₁-C₄)-haloalkyl or (C₁-C₄)-alkoxy,
R¹ represents (C₁-C₁₀-alkyl, (C₂-C₁₀)-alkenyl, (C₂-C₁₀)-alkynyl, halo-(C₁-C₁₀-alkyl, halo-(C₂-C₁₀)-alkenyl, halo-(C₂-C₁₀)-alkynyl, (C₃-C₁₀)-cyclo alkyl, halo-(C₃-C₁₀)-cyclo alkyl, (C₁-C₄)-alkyl-(C₃-C₇)-cycloalkyl, (C₃-C₇)-cycloalkyl-(C₁-C₆)-alkyl, (C₃-C₇)-cycloalkyl-(C₃-C₇)-cycloalkyl, halo-(C₃-C₇)-cycloalkyl-(C₁-C₆)-alkyl, (C₁-C₆)-alkyl-(C₃-C₇)-cycloalkyl-(C₁-C₆)-alkyl, (C₃-C₁₂)-cycloalkenyl, halo-(C₃-C₁₂)-cycloalkenyl, (C₁-C₆)-alkoxy-(C₁-C₆)-alkyl, (C₁-C₆)-alkoxy-(C₂-C₆)-alkenyl, (C₁-C₆)-alkyl-(C₃-C₇)-cycloalkyl, (C₁-C₆)-alkoxy-(C₃-C₇)-cycloalkyl, di-(C₁-C₆)-alkoxy-(C₃-C₇)-cyclo alkyl, (C₃-C₇)-cyclo alkoxy-(C₁-C₆)-alkyl, (C₃-C₇)-cyclo alkoxy-(C₁-C₆)-alkoxy-(C₁-C₆)-alkyl, (C₁-C₆)-alkoxy-(C₁-C₆)-alkoxy-(C₁-C₆)-alkyl, (C₁-C₆)-alkylthio-(C₁-C₆)-alkyl, (C₁-C₆)-alkylsulfinyl-(C₁-C₆)-alkyl, (C₁-C₆)-alkylsulfonyl-(C₁-C₆)-alkyl, (C₁-C₆)-alkylamino-(C₁-C₆)-alkyl, di-(C₁-C₆)-alkylamino-(C₁-C₆)-alkyl, halo-(C₁-C₆)-alkylamino-(C₁-C₆)-alkyl, (C₃-C₇)-cyclo alkylamino-(C₁-C₆)-alkyl, (C₁-C₆)-alkyl-carbonyl, halo-(C₁-C₆)-alkyl-carbonyl, (C₃-C₇)-cycloalkyl-carbonyl, (C₁-C₆)-alkoxy-carbonyl, (C₃-C₇)-cycloalkoxy-carbonyl, (C₃-C₇)-cycloalkyl-(C₁-C₆)-alkoxy-carbonyl, (C₁-C₆)-alkylamino-carbonyl, di-(C₁-C₆)-alkylamino-carbonyl, (C₃-C₇)-cycloalkylamino-carbonyl, cyano-(C₁-C₆)-alkyl, hydroxy-(C₁-C₆)-alkyl, (C₃-C₇)-cycloalkenyl-(C₁-C₆)-alkyl, halo-(C₁-C₆)-alkoxy-(C₁-C₆)-alkyl, (C₁-C₆)-alkoxy-halo-(C₁-C₆)-alkyl, halo-(C₁-C₆)-alkoxy-halo-(C₁-C₆)-alkyl, halo-(C₃-C₇)-cycloalkoxy-(C₁-C₆)-alkyl, (C₃-C₇)-cycloalkenyloxy-(C₁-C₆)-alkyl, halo-(C₃-C₇)-cycloalkenyloxy-(C₁-C₆)-alkyl, di-(C₁-C₆)-alkoxy-(C₁-C₆)-alkyl, (C₁-C₆)-alkoxy-(C₁-C₆)-alkyl-carbonyl, (C₁-C₆)-alkoxy-carbonyl-(C₁-C₆)-alkyl, halo-(C₁-C₆)-alkoxy-carbonyl, (C₁-C₁₀)-alkoxy, halo-(C₁-C₁₀)-alkoxy, (C₃-C₁₂)-cycloalkoxy, halo-(C₃-C₇)-cycloalkoxy, (C₃-C₇)-cycloalkyl-(C₁-C₆)-alkoxy, (C₂-C₁₂)-alkenyloxy, halo-(C₂-C₁₀)-alkenyloxy, (C₂-C₁₀)-alkynyloxy, halo-(C₃-C₁₀)-alkynyloxy, (C₁-C₆)-alkoxy-(C₁-C₆)-alkoxy, (C₁-C₆)-alkyl-carbonyloxy, halo-(C₂-C₁₂)-alkyl-carbonyloxy, (C₃-C₇)-cycloalkyl-carbonyloxy, (C₁-C₆)-alkyl-carbonyl-(C₁-C₆)-alkoxy, (C₁-C₆)-alkylamino, di-(C₁-C₆)-alkylamino, halo-(C₁-C₆)-alkylamino, halo-di-(C₁-C₆)-alkylamino, (C₃-C₁₂)-cycloalkylamino, (C₁-C₆)-alkyl-carbonylamino, halo-(C₁-C₆)-alkyl-carbonylamino, (C₁-C₁₀)-alkylsulfonylamino, halo-(C₁-C₁₀)-alkylsulfonylamino, (C₃-C₇)-cycloalkyl-(C₁-C₆)-alkyl-amino, hydroxy, amino, NHCHO, or
R¹ represents phenyl, phenylsulfonyl, W¹-(phenyl), W¹—(O-phenyl), W′-(S-phenyl), W¹-(SO₂-phenyl), W²—(SO₂CH₂-phenyl) or W²—(SCH₂-phenyl), where the phenyl rings of the eight above-mentioned radicals each carry s substituents R⁶,
R² represents hydrogen, (C₁-C₄)-alkyl, (C₁-C₄)-haloalkyl, (C₂-C₆)-alkenyl, (C₂-C₆)-haloalkenyl, (C₂-C₆)-alkynyl, (C₂-C₆)-haloalkynyl, (C₃-C₆)-cycloalkyl, (C₃-C₆)-halocycloalkyl, (C₁-C₆)-alkyl-O—(C₁-C₆)-alkyl, (C₃-C₆)-cycloalkyl-(C₁-C₆)-alkyl, phenyl, phenyl-(C₁-C₆)-alkyl, pyridyl or (C₁-C₆)-alkylpyridyl, where the phenyl or pyridyl rings of the four abovementioned radicals each carry s substituents R⁶,

Q represents a radical Q⁵, Q⁶, Q⁷ or Q⁸,

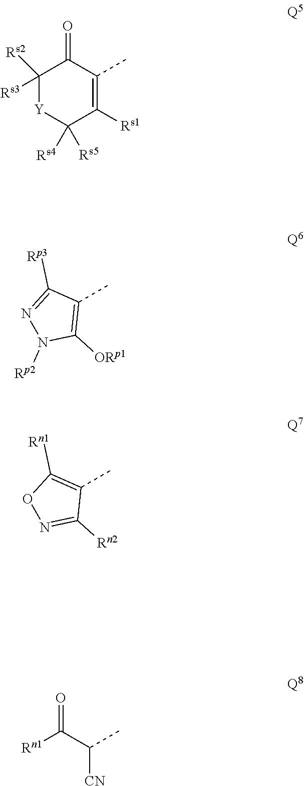

Y represents O, CO or CR^{s6}R^{s7},

R^{s1} represents hydroxy or SR⁷,

R^{s2} and R^{s5} independently of one another each represent hydrogen or (C₁-C₄)-alkyl, or

R^{s2} and R^{s5} together form an ethylene or vinylene group,

R^{s3}, R^{s4}, R^{s6} and R^{s7} independently of one another each represent hydrogen or (C₁-C₄)-alkyl,

R^{p1} represents hydrogen, (C₁-C₆)-alkylsulfonyl, (C₁-C₄)-alkoxy-(C₁-C₆)-alkylsulfonyl, or represents phenylsulfonyl, thiophenyl-2-sulfonyl, benzoyl, benzoyl-(C₁-C₆)-alkyl or benzyl, each of which is substituted by m identical or different radicals from the group consisting of halogen, (C₁-C₄)-alkyl and (C₁-C₄)-alkoxy,

R^{p2} represents (C₁-C₄)-alkyl,

R^{p3} represents hydrogen, (C₁-C₄)-alkyl, (C₃-C₈)-cycloalkyl, (C₁-C₄)-alkyl-(C₃-C₈)-cycloalkyl, (C₃-C₆)-halocycloalkyl,

Rⁿ¹ represents (C₁-C₄)-alkyl, (C₃-C₈)-cycloalkyl, (C₁-C₄)-alkyl-(C₃-C₈)-cycloalkyl, (C₃-C₆)-halocycloalkyl,

Rⁿ² represents hydrogen, CO₂(C₁-C₆)-alkyl or S(O)ₙ(C₁-C₆)-alkyl,

W¹ represents (C₁-C₁₀)-alkylene, (C₂-C₆)-alkenylene or (C₂-C₆)-alkynylene,

W² represents (C₁-C₁₀)-alkylene,

R⁶ represents halogen, cyano, hydroxy, amino, nitro, —C(═O)R^{6a}, —C(═O)OR^{6a}, —C(═O)(NR^{6a})₂, —C(═S)NH₂, —C(═O)NHCN, —C(═O)NHOH, —SH, —SO₂(NR^{6a})₂, —SO₂NHCN, —SO₂NHOH, —OCN, —SCN, —SF₅, (C₁-C₆)-alkyl, (C₂-C₆)-alkenyl, (C₂-C₆)-alkynyl, halo-(C₁-C₆)-alkyl, halo-(C₂-C₆)-alkenyl, halo-(C₂-C₆)-alkynyl, (C₃-C₈)-cycloalkyl, halo-(C₃-C₈)-cycloalkyl, (C₁-C₆)-alkyl-(C₃-C₇)-cycloalkyl, (C₃-C₇)-cycloalkyl-(C₁-C₆)-alkyl, (C₃-C₈)-cycloalkenyl, halo-(C₃-C₈)-cycloalkenyl, (C₁-C₆)-alkoxy-(C₁-C₆)-alkyl, (C₃-C₇)-cycloalkoxy-(C₁-C₆)-alkyl, (C₁-C₆)-alkoxy-(C₁-C₆)-alkoxy-(C₁-C₆)-alkyl, (C₁-C₆)-alkylthio-(C₁-C₆)-alkyl, (C₁-C₈)-alkylsulfinyl-(C₁-C₆)-alkyl, (C₁-C₈)-alkoxyhalo-(C₁-C₆)-alkyl, cyano-(C₁-C₆)-alkyl, hydroxy-(C₁-C₆)-alkyl, (C₁-C₆)-alkoxy, halo-(C₁-C₆)-alkoxy, (C₃-C₈)-cycloalkoxy, halo-(C₃-C₈)-cycloalkoxy, (C₃-C₈)-cycloalkyl-(C₁-C₆)-alkoxy, (C₂-C₆)-alkenyloxy, halo-(C₂-C₆)-alkenyloxy, (C₁-C₆)-alkoxy-(C₁-C₆)-alkoxy, (C₂-C₆)-alkylcarbonyloxy, (C₁-C₆)-alkylthio, halo-(C₁-C₆)-alkylthio, (C₃-C₈)-cycloalkylthio, (C₁-C₆)-alkylsulfinyl, halo-(C₁-C₆)-alkylsulfinyl, (C₁-C₆)-alkylsulfonyl, halo-(C₁-C₆)-alkylsulfonyl, (C₃-C₈)-cycloalkylsulfonyl, (C₁-C₆)-alkylamino, di-(C₁-C₆)-alkylamino, halo-(C₁-C₆)-alkylamino, halodi-(C₁-C₈)-alkylamino or (C₃-C₈)-cycloalkylamino, or two vicinal R³ radicals together with the two carbon atoms to which they are attached form a 5- to 7-membered ring which contains v carbon atoms and p identical or different atoms from the group of oxygen, sulfur and nitrogen, and carries t oxo groups,

R^{6a} represents hydrogen, (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl or phenyl,

R⁷ represents (C₁-C₄)-alkyl, or phenyl substituted by p radicals from the group of halogen, nitro, cyano, (C₁-C₄)-alkyl, (C₁-C₄)-haloalkyl, (C₁-C₄)-alkoxy and (C₁-C₄)-haloalkoxy,

n represents 0, 1 or 2,

P represents 0, 1, 2, 3 or 4,

s represents 0, 1, 2, 3, 4 or 5,

t represents 0, 1, 2, 3 or 4,

v represents 2, 3, 4, 5, 6 or 7,

and

(B) one or more safeners.

The terms “herbicides (A)” and “compounds of the general formula (I)” should be understood to be equivalent in the present application.

The herbicide safener compositions according to the invention may comprise or be used together with additional further components, for example other kinds of active crop protection compounds and/or additives and/or formulation auxiliaries customary in crop protection.

The herbicides (A) and the safeners (B) can be applied in a known manner, for example together (for example as a co-formulation or as a tank-mix) or else at different times (splitting), for example to the plants, plant parts, plant seeds or the area on which the plants grow. It is possible, for example, to apply the individual active compounds or the herbicide safener composition in several portions (sequential application), for example pre-emergence applications followed by post-emergence applications, or early post-emergence applications followed by post-emergence applications at an intermediate or late stage. Preference is given to the joint or immediately successive application of the active compounds of the composition in question. It is also possible to use the individual active compounds or the herbicide safener composition for seed treatment.

Preference is given to those herbicide safener compositions according to the invention which comprise, as herbicide (A), those compounds of the general formula (I) and salts thereof in which

X represents halogen, (C₁-C₆)-alkyl, (C₁-C₆)-haloalkyl, (C₂-C₆)-alkenyl, (C₃-C₆)-cycloalkyl, (C₃-C₆)-halocycloalkyl, OR¹, S(O)ₙR², SO₂N(R¹)₂, NR¹SO₂R², NR¹COR¹, (C₁-C₆)-alkyl-S(O)ₙR² or (C₁-C₆)-alkyl-OR¹,

Z represents O,

W represents hydrogen, F, Cl, MeO, methyl or ethyl,

R¹ represents (C₁-C₁₀-alkyl, (C₂-C₁₀)-alkenyl, (C₂-C₁₀)-alkynyl, halo-(C₁-C₁₀-alkyl, halo-(C₂-C₁₀)-alkenyl, halo-(C₂-C₁₀)-alkynyl, (C₃-C₁₀)-cyclo alkyl, halo-(C₃-C₁₀)-cyclo alkyl, (C₁-C₄)-alkyl-(C₃-C₇)-cycloalkyl, (C₃-C₇)-cycloalkyl-(C₁-C₆)-alkyl, (C₁-C₆)-alkoxy-(C₁-C₆)-alkyl, (C₁-C₆)-alkyl-(C₃-C₇)-cycloalkyl, (C₁-C₆)-alkylthio-(C₁-C₆)-alkyl, (C₁-C₆)-alkylsulfinyl-(C₁-C₆)-alkyl, (C₁-C₆)-alkylsulfonyl-(C₁-C₆)-alkyl, cyano-(C₁-C₆)-alkyl, (C₁-C₁₀)-alkoxy, halo-(C₁-C₁₀)-alkoxy, (C₁-C₆)-alkoxy-(C₁-C₆)-alkoxy, (C₁-C₆)-alkylamino or di-(C₁-C₆)-alkylamino,

R¹ represents phenyl carrying s substituents R⁶,

R² represents (C₁-C₄)-alkyl,

Q represents a radical Q⁵, Q⁶, Q⁷ or Q⁸,

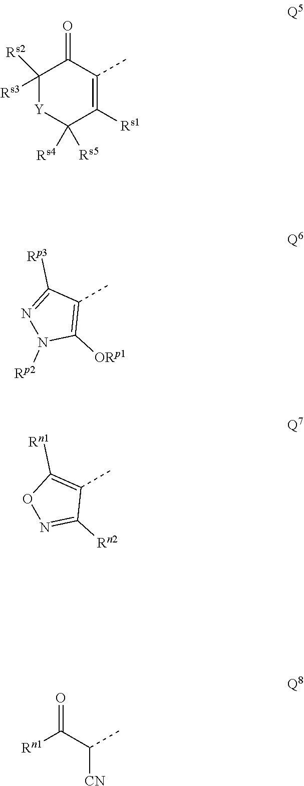

R⁶ represents halogen, cyano, hydroxy, amino, nitro, —C(═O)R^{6a}, —C(═O)OR^{6a}, —C(═O)(NR^{6a})₂, —C(═S)NH₂, —C(═O)NHCN, —C(═O)NHOH, —SH, —SO₂NH₂, —SO₂NHCN, —SO₂NHOH, —OCN, —SCN, —SF₅, (C₁-C₆)-alkyl, (C₂-C₆)-alkenyl, (C₂-C₆)-alkynyl, halo-(C₁-C₆)-alkyl, halo-(C₂-C₆)-alkenyl, halo-(C₂-C₆)-alkynyl, (C₃-C₈)-cycloalkyl, halo-(C₃-C₈)-cycloalkyl, (C₁-C₆)-alkyl-(C₃-C₇)-cycloalkyl, (C₃-C₇)-cycloalkyl-(C₁-C₆)-alkyl, (C₃-C₈)-cycloalkenyl, halo-(C₃-C₈)-cycloalkenyl, (C₁-C₆)-alkoxy-(C₁-C₆)-alkyl, (C₃-C₇)-cycloalkoxy-(C₁-C₆)-alkyl, (C₁-C₆)-alkoxy-(C₁-C₆)-alkoxy-(C₁-C₆)-alkyl, (C₁-C₆)-alkylthio-(C₁-C₆)-alkyl, (C₁-C₈)-alkylsulfinyl-(C₁-C₆)-alkyl, (C₁-C₈)-alkoxyhalo-(C₁-C₆)-alkyl, cyano-(C₁-C₆)-alkyl, hydroxy-(C₁-C₆)-alkyl, (C₁-C₆)-alkoxy, halo-(C₁-C₆)-alkoxy, (C₃-C₈)-cycloalkoxy, halo-(C₃-C₈)-cycloalkoxy, (C₃-C₈)-cycloalkyl-(C₁-C₆)-alkoxy, (C₂-C₆)-alkenyloxy, halo-(C₂-C₆)-alkenyloxy, (C₁-C₆)-alkoxy-(C₁-C₆)-alkoxy, (C₂-C₆)-alkylcarbonyloxy, (C₁-C₆)-alkylthio, halo-(C₁-C₆)-alkylthio, (C₃-C₈)-cycloalkylthio, (C₁-C₆)-alkylsulfinyl, halo-(C₁-C₆)-alkylsulfinyl, (C₁-C₆)-alkylsulfonyl, halo-(C₁-C₆)-alkylsulfonyl, (C₃-C₈)-cycloalkylsulfonyl, (C₁-C₆)-alkylamino, di-(C₁-C₆)-alkylamino, halo-(C₁-C₆)-alkylamino, halodi-(C₁-C₈)-alkylamino, (C₃-C₈)-cycloalkylamino or methylenedioxo,

R^{6a} represents hydrogen or (C₁-C₆)-alkyl,

Y represents O, CO or CR^{s6}R^{s7},

R^{s1} represents hydroxy,

R^{s2} and R^{s5} independently of one another each represent hydrogen or methyl, or

R^{s2} and R^{s5} together form an ethylene or vinylene group,

R^{s3}, R^{s4}, R^{s6} and R^{s7} independently of one another each represent hydrogen or methyl,

R^{p1} represents hydrogen,

R^{p2} represents (C₁-C₄)-alkyl,

R^{p3} represents hydrogen, (C₁-C₄)-alkyl or cyclopropyl,

Rⁿ¹ represents cyclopropyl,

Rⁿ² represents hydrogen,

n represents 0, 1 or 2,

p represents 0, 1, 2, 3 or 4,

s represents 0, 1, 2, 3, 4 or 5.

The compounds of the formula (I) present in the herbicide safener compositions according to the invention and the safeners described below can each form salts. Salts can be formed by the action of a base on those compounds of the formula (I) or safeners which bear an acidic hydrogen atom, for example in the case that R¹ contains a COOH group or a sulfonamide group NHSO₂. Suitable bases are, for example, organic amines such as trialkylamines, morpholine, piperidine or pyridine, and also ammonium, alkali metal or alkaline earth metal hydroxides, carbonates and hydrogencarbonates, especially NaOH, KOH, Na₂CO₃, K₂CO₃, NaHCO₃, and KHCO₃. These salts are compounds in which the acidic hydrogen is replaced by an agriculturally suitable cation, for example metal salts, especially alkali metal salts or alkaline earth metal salts, especially sodium and potassium salts, or else ammonium salts, salts with organic amines or quaternary ammonium salts, for example with cations of the formula [NRR′R″R′″]⁺ in which R to R′″ are each independently an organic radical, especially alkyl, aryl, aralkyl or alkylaryl. Also suitable are alkylsulfonium and alkylsulfoxonium salts, such as (C₁-C₄)-trialkylsulfonium and (C₁-C₄)-trialkylsulfoxonium salts.

The compounds of the formula (I) present in the herbicide safener compositions according to the invention, and the safeners described below, can each form salts through addition of a suitable inorganic or organic acid, for example mineral acids such as HCl, HBr, H₂SO₄, H₃PO₄ or HNO₃, or organic acids, for example carboxylic acids such as formic acid, acetic acid, propionic acid, oxalic acid, lactic acid or salicylic acid, or sulfonic acids, for example p-toluenesulfonic acid, onto a basic group, for example amino, alkylamino, dialkylamino, piperidino, morpholino or pyridino. In such a case, these salts comprise the conjugated base of the acid as the anion. Suitable substituents present in deprotonated form, such as, for example, sulfonic acids or carboxylic acids, may form inner salts with groups which for their part can be protonated, such as amino groups.

In the case of radicals with carbon atoms, preference is given in principle to those having 1 to 6 carbon atoms, preferably 1 to 4 carbon atoms, especially 1 or 2 carbon atoms.

Examples of compounds used as herbicide (A) are listed in the following tables:

In these tables, the abbreviations used mean:

| | | |
|---|---|---|
| Me = methyl | Et = ethyl | Ph = phenyl |

TABLE 1
Compounds of the general formula (I) according to the invention
in which Q represents Q⁵, Y represents a CR^{s6}R^{s7} group, R^{s1}
represents hydroxy, R^{s2}, R^{s3}, R^{s4}, R^{s5} and W represent
hydrogen and R² represents methyl, and Z represents oxygen.

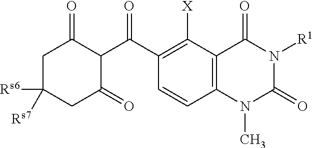

| No. | R^{s6} | R^{s7} | X | R¹ |
|---|---|---|---|---|
| A4-1 | H | H | Me | Ph |
| A4-2 | H | H | Me | 2-Me—Ph |
| A4-3 | H | H | Me | 3-Me—Ph |
| A4-4 | H | H | Me | 4-Me—Ph |
| A4-5 | H | H | Me | 2-Et—Ph |
| A4-6 | H | H | Me | 2-CF₃—Ph |
| A4-7 | H | H | Me | 3-CF₃—Ph |
| A4-8 | H | H | Me | 4-CF₃—Ph |
| A4-9 | H | H | Me | 2-CN—Ph |
| A4-10 | H | H | Me | 2-NO₂—Ph |
| A4-11 | H | H | Me | 3-NO₂—Ph |
| A4-12 | H | H | Me | 4-NO₂—Ph |
| A4-13 | H | H | Me | 2-MeO—Ph |
| A4-14 | H | H | Me | 3-MeO—Ph |
| A4-15 | H | H | Me | 4-MeO—Ph |
| A4-16 | H | H | Me | 2-F—Ph |
| A4-17 | H | H | Me | 3-F—Ph |
| A4-18 | H | H | Me | 4-F—Ph |
| A4-19 | H | H | Me | 2-Cl—Ph |
| A4-20 | H | H | Me | 3-Cl—Ph |
| A4-21 | H | H | Me | 4-Cl—Ph |
| A4-22 | H | H | Me | 2,6-Me₂—Ph |
| A4-23 | H | H | Me | 2-Me, 4-F—Ph |
| A4-24 | H | H | Me | 2,4-(MeO)₂—Ph |
| A4-25 | H | H | Me | 3,4,5-(MeO)₃—Ph |
| A4-26 | H | H | Me | 3-Cl, 4-MeO—Ph |
| A4-27 | Me | Me | Me | 2-Me—Ph |
| A4-28 | Me | Me | Me | 2-Et—Ph |
| A4-29 | Me | Me | Me | 2-CF₃—Ph |
| A4-30 | Me | Me | Me | 2-CN—Ph |
| A4-31 | Me | Me | Me | 2-NO₂—Ph |
| A4-32 | Me | Me | Me | 2-MeO—Ph |
| A4-33 | Me | Me | Me | 2-F—Ph |
| A4-34 | Me | Me | Me | 2-Cl—Ph |
| A4-35 | Me | Me | Me | 2,6-Me₂—Ph |
| A4-36 | Me | Me | Me | 2-Me, 4-F—Ph |

TABLE 2
Compounds of the general formula (I) according to the invention
in which Q represents Q³, R² represents methyl, W and R^{p1}
represent hydrogen, and Z represents oxygen.

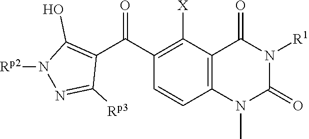

| No. | R^{p2} | R^{p3} | X | R¹ |
|---|---|---|---|---|
| A5-1 | Me | H | Me | Ph |
| A5-2 | Me | H | Me | 2-Me—Ph |
| A5-3 | Me | H | Me | 3-Me—Ph |
| A5-4 | Me | H | Me | 4-Me—Ph |
| A5-5 | Me | H | Me | 2-Et—Ph |
| A5-6 | Me | H | Me | 2-CF₃—Ph |
| A5-7 | Me | H | Me | 3-CF₃—Ph |
| A5-8 | Me | H | Me | 4-CF₃—Ph |
| A5-9 | Me | H | Me | 2-CN—Ph |
| A5-10 | Me | H | Me | 2-NO₂—Ph |
| A5-11 | Me | H | Me | 3-NO₂—Ph |
| A5-12 | Me | H | Me | 4-NO₂—Ph |
| A5-13 | Me | H | Me | 2-MeO—Ph |
| A5-14 | Me | H | Me | 3-MeO—Ph |
| A5-15 | Me | H | Me | 4-MeO—Ph |
| A5-16 | Me | H | Me | 2-F—Ph |
| A5-17 | Me | H | Me | 3-F—Ph |
| A5-18 | Me | H | Me | 4-F—Ph |
| A5-19 | Me | H | Me | 2-Cl—Ph |
| A5-20 | Me | H | Me | 3-Cl—Ph |
| A5-21 | Me | H | Me | 4-Cl—Ph |
| A5-22 | Me | H | Me | 2,6-Me₂—Ph |
| A5-23 | Me | H | Me | 2-Me, 4-F—Ph |
| A5-24 | Me | H | Me | 2,4-(MeO)₂—Ph |
| A5-25 | Me | H | Me | 3,4,5-(MeO)₃—Ph |
| A5-26 | Me | H | Me | 3-Cl, 4-MeO—Ph |
| A5-27 | Me | Me | Me | 2-Me—Ph |
| A5-28 | Me | Me | Me | 2-Et—Ph |
| A5-29 | Me | Me | Me | 2-CF₃—Ph |
| A5-30 | Me | Me | Me | 2-CN—Ph |
| A5-31 | Me | Me | Me | 2-NO₂—Ph |
| A5-32 | Me | Me | Me | 2-MeO—Ph |
| A5-33 | Me | Me | Me | 2-F—Ph |
| A5-34 | Me | Me | Me | 2-Cl—Ph |
| A5-35 | Me | Me | Me | 2,6-Me₂—Ph |
| A5-36 | Me | Me | Me | 2-Me, 4-F—Ph |
| A5-37 | Et | H | Me | 2-Me—Ph |
| A5-38 | Et | H | Me | 2-Et—Ph |
| A5-39 | Et | H | Me | 2-CF₃—Ph |
| A5-40 | Et | H | Me | 2-CN—Ph |
| A5-41 | Et | H | Me | 2-NO₂—Ph |
| A5-42 | Et | H | Me | 2-MeO—Ph |
| A5-43 | Et | H | Me | 2-F—Ph |
| A5-44 | Et | H | Me | 2-Cl—Ph |
| A5-45 | Et | H | Me | 2,6-Me₂—Ph |
| A5-46 | Et | H | Me | 2-Me, 4-F—Ph |

The application rate of the herbicides (A) can vary within a wide range with the outdoor conditions, such as temperature, humidity and the type of herbicide used, for example between 0.001 g and 2000 g a.i./ha (ai/ha hereinafter means “active substance per hectare”=based on 100% active compound).

In the case of pre- and post-emergence applications at application rates of 0.01 g to 1000 g a.i./ha of the herbicides (A), a relatively broad spectrum of harmful plants, for example annual and perennial mono- or dicotyledonous weeds, and of unwanted crop plants is controlled. For the herbicide safener compositions according to the invention, the application rates are generally relatively low, for example in the range from 0.1 g to 800 g a.i./ha, preferably 1 g to 500 g a.i./ha, more preferably 10 g to 400 g a.i./ha.

The herbicides (A) are suitable for control of harmful plants, for example in plant crops, for example in economically important farm crops, e.g. monocotyledonous farm crops such as cereals (e.g. wheat, barley, rye, oats), rice, corn, millet/sorghum, or dicotyledonous farm crops such as sugar beet, oilseed rape, cotton, sunflower and legumes, for example of the genera Glycine (e.g. Glycine max. (soya) such as non-transgenic Glycine max. (e.g. conventional varieties such as STS varieties) or transgenic Glycine max. (e.g. RR soya or LL soya) and crosses thereof), Phaseolus, Pisum, Vicia and Arachis, or vegetable crops from various botanic groups, such as potato, leek, cabbage, carrot, tomato, onion, and permanent crops and plantation crops such as pome fruit and stone fruit, berries, grapes, hevea, bananas, sugar cane, coffee, tea, citrus, nut plantations, lawns, palm crops and forestry crops. For the use of the herbicide safener compositions (A)+(B) according to the invention, these crops are likewise preferred, particular preference being given to use in cereals (e.g. wheat, barley, rye, oats), rice, corn, millet/sorghum, sugar beet, sugar cane, sunflower, oilseed rape and cotton. The herbicide safener compositions (A)+(B) can also be used in tolerant and nontolerant mutant crops and tolerant and nontolerant transgenic crops, preferably of corn, rice, cereals, oilseed rape and soya, for example those which are resistant to imidazolinone herbicides, atrazine, glufosinate or glyphosate.

The safeners present as component (B) are understood to mean compounds suitable for reducing phytotoxic effects of active compounds of crop protection compositions, such as herbicides, on crop plants.

In the context of the present invention, the herbicides (A) are combined with the following safener compounds:

S1) Compounds from the group of heterocyclic carboxylic acid derivatives:

S1^{a}) Compounds of the dichlorophenylpyrazoline-3-carboxylic acid type (S1^{a}), preferably compounds such as 1-(2,4-dichlorophenyl)-5-(ethoxycarbonyl)-5-methyl-2-pyrazoline-3-carboxylic acid, ethyl 1-(2,4-dichlorophenyl)-5-(ethoxycarbonyl)-5-methyl-2-pyrazoline-3-carboxylate (S1-1) (“mefenpyr-diethyl”), and related compounds as described in WO-A-91/07874;

S1^{b}) Derivatives of dichlorophenylpyrazolecarboxylic acid (S1^{b}), preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4) and related compounds as described in EP-A-333 131 and EP-A-269 806;

S1^{c}) Derivatives of 1,5-diphenylpyrazole-3-carboxylic acid (S1^{c}), preferably compounds such as ethyl 1-(2,4-dichlorophenyl)-5-phenylpyrazole-3-carboxylate (S1-5), methyl 1-(2-chlorophenyl)-5-phenylpyrazole-3-carboxylate (S1-6) and related compounds as described, for example, in EP-A-268554;

S1^{d}) Compounds of the triazolecarboxylic acid type (S1^{d}), preferably compounds such as fenchlorazole (ethyl ester), i.e. ethyl 1-(2,4-dichlorophenyl)-5-trichloromethyl-1H-1,2,4-triazole-3-carboxylate (S1-7), and related compounds, as described in EP-A-174 562 and EP-A-346 620;

S1^{e}) Compounds of the 5-benzyl- or 5-phenyl-2-isoxazoline-3-carboxylic acid type or of the 5,5-diphenyl-2-isoxazoline-3-carboxylic acid type (S1^{e}), preferably compounds such as ethyl 5-(2,4-dichlorobenzyl)-2-isoxazoline-3-carboxylate (S1-8) or ethyl 5-phenyl-2-isoxazoline-3-carboxylate (S1-9) and related compounds as described in WO-A-91/08202, or 5,5-diphenyl-2-isoxazolinecarboxylic acid (S1-10) or ethyl 5,5-diphenyl-2-isoxazolinecarboxylate (S1-11) (“isoxadifen-ethyl”) or n-propyl 5,5-diphenyl-2-isoxazolinecarboxylate (S1-12) or ethyl 5-(4-fluorophenyl)-5-phenyl-2-isoxazoline-3-carboxylate (S1-13), as described in patent application WO-A-95/07897.

S2) Compounds from the group of the 8-quinolinyloxy derivatives (S2):

S2^{a}) Compounds of the 8-quinolinoxyacetic acid type (S2^{a}), preferably 1-methylhexyl (5-chloro-8-quinolinoxy)acetate (“cloquintocet-mexyl”) (S2-1), 1,3-dimethylbut-1-yl (5-chloro-8-quinolinoxy)acetate (S2-2), 4-allyloxybutyl (5-chloro-8-quinolinoxy)acetate (S2-3), 1-allyloxyprop-2-yl (5-chloro-8-quinolinoxy)acetate (S2-4), ethyl (5-chloro-8-quinolinoxy)acetate (S2-5), methyl (5-chloro-8-quinolinoxy)acetate (S2-6), allyl (5-chloro-8-quinolinoxy)acetate (S2-7), 2-(2-propylideneiminoxy)-1-ethyl (5-chloro-8-quinolinoxy)acetate (S2-8), 2-oxoprop-1-yl (5-chloro-8-quinolinoxy)acetate (S2-9) and related compounds, as described in EP-A-86 750, EP-A-94 349 and EP-A-191 736 or EP-A-0 492 366, and also (5-chloro-8-quinolinoxy)acetic acid (S2-10), hydrates and salts thereof, for example the lithium, sodium, potassium, calcium, magnesium, aluminum, iron, ammonium, quaternary ammonium, sulfonium or phosphonium salts thereof, as described in WO-A-2002/34048;

S2^{b}) Compounds of the (5-chloro-8-quinolinoxy)malonic acid type (S2^{b}), preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.

S3) Active compounds of the dichloroacetamide type (S3), which are frequently used as pre-emergence safeners (soil-acting safeners), for example “dichlormid” (N,N-diallyl-2,2-dichloroacetamide) (S3-1), “R-29148” (3-dichloroacetyl-2,2,5-trimethyl-1,3-oxazolidine) from Stauffer (S3-2), “R-28725” (3-dichloroacetyl-2,2-dimethyl-1,3-oxazolidine) from Stauffer (S3-3), “benoxacor” (4-dichloroacetyl-3,4-dihydro-3-methyl-2H-1,4-benzoxazine) (S3-4), “PPG-1292” (N-allyl-N-[(1,3-dioxolan-2-yl)methylldichloroacetamide) from PPG Industries (S3-5), “DKA-24” (N-allyl-N-Rallylaminocarbonyl)methylldichloroacetamide) from Sagro-Chem (53-6), “AD-67” or “MON 4660” (3-dichloroacetyl-1-oxa-3-azaspiro[4.5]decane) from Nitrokemia or Monsanto (S3-7), “TI-35” (1-dichloroacetylazepane) from TRI-Chemical RT (53-8), “diclonon” (dicyclonon) (synonym: “BAS145138” or “LAB145138”) (RS)-1-dichloroacetyl-3,3,8a-trimethylperhydropyrrolo[1,2-alpyrimidin-6-one from BASF (53-9), “furilazole” or “MON 13900” ((RS)-3-dichloroacetyl-5-(2-furyl)-2,2-dimethyloxazolidine) (S3-10), and the (R) isomer thereof (S3-11).

S4) Compounds from the class of the acylsulfonamides (S4):

S4a) N-Acylsulfonamides of the formula (S4a) and salts thereof, as described in WO-A-97/45016,

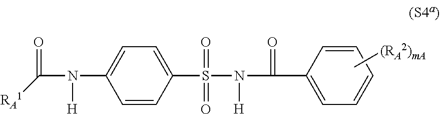

in which

R_{A}¹ represents (C₁-C₆)-alkyl or (C₃-C₆)-cycloalkyl, where these radicals are substituted by v_{A} substituents from the group of halogen, (C₁-C₄)-alkoxy, (C₁-C₆)-haloalkoxy and (C₁-C₄)-alkylthio and, in the case of cyclic radicals, also by (C₁-C₄)-alkyl and (C₁-C₄)-haloalkyl;

R_{A}² represents halogen, (C₁-C₄)-alkyl, (C₁-C₄)-alkoxy, CF₃;

m_{A} represents 1 or 2;

v_{A} represents 0, 1, 2 or 3.

S4^{b}) Compounds of the 4-(benzoylsulfamoyl)benzamide type of the formula (S4^{b}) and salts thereof, as described in WO-A-99/16744,

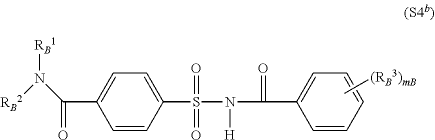

in which

R_{B}¹, R_{B}² each independently of one another represent hydrogen, (C₁-C₆)-alkyl, (C₃-C₆)-cycloalkyl, (C₃-C₆)-alkenyl or (C₃-C₆)-alkynyl,

R_{B}³ represents halogen, (C₁-C₄)-alkyl, (C₁-C₄)-haloalkyl or (C₁-C₄)-alkoxy and

m_{B} represents 1 or 2,

for example those in which

R_{B}¹=cyclopropyl, R_{B}²=hydrogen and (R_{B}³)=2-OMe (S4-1, “cyprosulfamide”),

R_{B}¹=cyclopropyl, R_{B}²=hydrogen and (R_{B}³)=5-Cl-2-OMe (S4-2),

R_{B}¹=ethyl, R_{B}²=hydrogen and (R_{B}³)=2-OMe (S4-3),

R_{B}¹=isopropyl, R_{B}²=hydrogen and (R_{B}³)=5-Cl-2-OMe (S4-4) and

R_{B}¹=isopropyl, R_{B}²=hydrogen and (R_{B}³)=2-OMe (S4-5).

S4^{c}) Compounds from the class of the benzoylsulfamoylphenylureas of the formula (S4^{c}), as described in EP-A-365484,

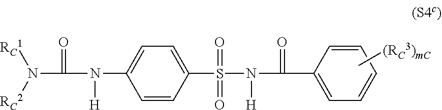

in which

R_{C}¹, R_{C}² each independently of one another represent hydrogen, (C₁-C₈)-alkyl, (C₃-C₈)-cycloalkyl, (C₃-C₆)-alkenyl or (C₃-C₆)-alkynyl,

R_{C}³ represents halogen, (C₁-C₄)-alkyl, (C₁-C₄)-alkoxy or CF₃;

m_{C} represents 1 or 2;

for example

1-[4-(N-2-methoxybenzoylsulfamoyl)phenyl]-3-methylurea (S4-6),

1-[4-(N-2-methoxybenzoylsulfamoyl)phenyl]-3,3-dimethylurea,

1-[4-(N-4,5-dimethylbenzoylsulfamoyl)phenyl]-3-methylurea.

S4^{d}) Compounds of the N-phenylsulfonylterephthalamide type of the following formula (S4^{d}) and salts thereof, which are known, for example, from CN 101838227,

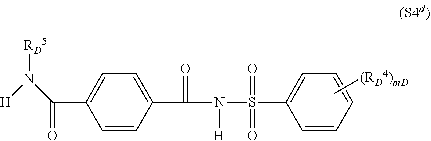

in which

R_{D}⁴ represents halogen, (C₁-C₄)-alkyl, (C₁-C₄)-alkoxy or CF₃;

m_{D} represents 1 or 2;

R_{D}⁵ represents hydrogen, (C₁-C₆)-alkyl, (C₃-C₆)-cycloalkyl, (C₂-C₆)-alkenyl, (C₂-C₆)-alkynyl or (C₅-C₆)-cycloalkenyl.

S5) Active compounds from the class of the hydroxyaromatics and the aromatic-aliphatic carboxylic acid derivatives (S5), for example ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicylic acid, 2-hydroxycinnamic acid, 2,4-dichlorocinnamic acid, as described in WO-A-2004/084631, WO-A-2005/015994, WO-A-2005/016001.

S6) Active compounds from the class of the 1,2-dihydroquinoxalin-2-ones (S6), for example 1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulfonylaminoethyl)-3-(2-thienyl)-1,2-dihydroquinoxalin-2-one, as described in WO-A-2005/112630.

S7) Compounds from the class of the diphenylmethoxyacetic acid derivatives (S7), e.g. methyl diphenylmethoxyacetate (CAS Reg. No. 41858-19-9) (S7-1), ethyl diphenylmethoxyacetate or diphenylmethoxyacetic acid, as described in WO-A-98/38856.

S8) Compounds of the formula (S8), as described in WO-A-98/27049,

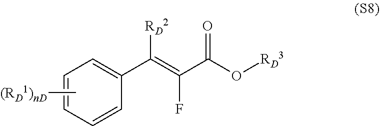

in which

R_{D}¹ represents halogen, (C₁-C₄)-alkyl, (C₁-C₄)-halo alkyl, (C₁-C₄)-alkoxy, (C₁-C₄)-haloalkoxy,

R_{D}² represents hydrogen or (C₁-C₄)-alkyl,

R_{D}³ represents hydrogen, (C₁-C₈)-alkyl, (C₂-C₄)-alkenyl, (C₂-C₄)-alkynyl or aryl, where each of the abovementioned carbon-containing radicals is unsubstituted or substituted by one or more, preferably up to three identical or different radicals from the group consisting of halogen and alkoxy; or salts thereof,

n_{D} represents 0, 1 or 2.

S9) Active compounds from the class of the 3-(5-tetrazolylcarbonyl)-2-quinolones (S9), for example 1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No. 95855-00-8), as described in WO-A-1999/000020.

S10) Compounds of the formula (S10^{a}) or (S10^{b})
as described in WO-A-2007/023719 and WO-A-2007/023764

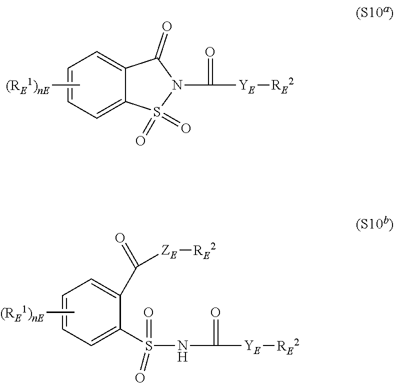

in which

R_{E}¹ represents halogen, (C₁-C₄)-alkyl, methoxy, nitro, cyano, CF₃, OCF₃

Y_{E}, Z_{E} each independently of one another represent O or S,

n_{E} represents 0, 1, 2, 3 or 4,

R_{E}² represents (C₁-C₁₆)-alkyl, (C₂-C₆)-alkenyl, (C₃-C₆)-cycloalkyl, aryl, benzyl or halobenzyl,

R_{E}³ represents hydrogen or (C₁-C₆)-alkyl.

S11) Active compounds of the oxyimino compound type (S11), which are known as seed-dressing agents, for example “oxabetrinil” ((Z)-1,3-dioxolan-2-ylmethoxyimino(phenyl)acetonitrile) (S11-1), which is known as a seed-dressing safener for millet/sorghum against metolachlor damage, “fluxofenim” (1-(4-chlorophenyl)-2,2,2-trifluoro-1-ethanone O-(1,3-dioxolan-2-ylmethyl)oxime) (S11-2), which is known as a seed-dressing safener for millet/sorghum against metolachlor damage, and “cyometrinil” or “CGA-43089” ((Z)-cyanomethoxyimino(phenyl)acetonitrile) (S11-3), which is known as a seed-dressing safener for millet/sorghum against metolachlor damage.

S12) Active compounds from the class of the isothiochromanones (S12), for example methyl [(3-oxo-1H-2-benzothiopyran-4(3H)-ylidene)methoxylacetate (CAS Reg. No. 205121-04-6) (S12-1) and related compounds from WO-A-1998/13361.

S13) One or more compounds from group (S13):

“naphthalic anhydride” (1,8-naphthalenedicarboxylic anhydride) (S13-1), which is known as a seed-dressing safener for maize against thiocarbamate herbicide damage,

“fenclorim” (4,6-dichloro-2-phenylpyrimidine) (S13-2), which is known as a safener for pretilachlor in sown rice,

“flurazole” (benzyl 2-chloro-4-trifluoromethyl-1,3-thiazole-5-carboxylate) (S13-3), which is known as a seed-dressing safener for millet/sorghum against alachlor and metolachlor damage,

“CL 304415” (CAS Reg. No. 31541-57-8)

(4-carboxy-3,4-dihydro-2H-1-benzopyran-4-acetic acid) (S13-4) from American Cyanamid, which is known as a safener for maize against damage by imidazolinones,

“MG 191” (CAS Reg. No. 96420-72-3) (2-dichloromethyl-2-methyl-1,3-dioxolane) (S13-5) from Nitrokemia, which is known as a safener for maize,

“MG-838” (CAS Reg. No. 133993-74-5)

(2-propenyl 1-oxa-4-azaspiro[4.5]decane-4-carbodithioate) (S13-6) from Nitrokemia

“disulfoton” (0,0-diethyl S-2-ethylthioethyl phosphorodithioate) (S13-7),

“dietholate” (0,0-diethyl 0-phenyl phosphorothioate) (S13-8),

“mephenate” (4-chlorophenyl methylcarbamate) (S13-9).

S14) Active compounds which, in addition to herbicidal action against harmful plants, also have safener action on crop plants such as rice, for example

“dimepiperate” or “MY-93” (S-1-methyl 1-phenylethylpiperidine-1-carbothioate), which is known as a safener for rice against damage by the herbicide molinate (S14-1),

“daimuron” or “SK 23” (1-(1-methyl-1-phenylethyl)-3-p-tolylurea), which is known as a safener for rice against damage by the herbicide imazosulfuron (S14-2),

“cumyluron”=“JC-940” (3-(2-chlorophenylmethyl)-1-(1-methyl-1-phenylethyl)urea, see JP-A-60087254), which is known as a safener for rice against damage by some herbicides (S14-3),

“methoxyphenone” or “NK 049” (3,3′-dimethyl-4-methoxybenzophenone), which is known as a safener for rice against damage by some herbicides,

“CSB” (1-bromo-4-(chloromethylsulfonyl)benzene) from Kumiai, (CAS Reg. No. 54091-06-4), which is known as a safener against damage by some herbicides in rice.

S15) Compounds of the formula (S15) or tautomers thereof as described in WO-A-2008/131861 and WO-A-2008/131860

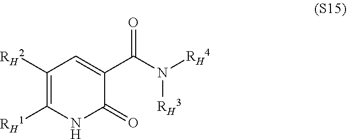

in which

R_{H}¹ represents a (C₁-C₆)-haloalkyl radical,

R_{H}² represents hydrogen or halogen,

R_{H}³, R_{H}⁴ each independently of one another represent hydrogen, (C₁-C₁₆)-alkyl, (C₂-C₁₆)-alkenyl or (C₂-C₁₆)-alkynyl,

where each of the 3 last-mentioned radicals is unsubstituted or substituted by one or more radicals from the group of halogen, hydroxy, cyano, (C₁-C₄)-alkoxy, (C₁-C₄)-haloalkoxy, (C₁-C₄)-alkylthio, (C₁-C₄)-alkylamino, di[(C₁-C₄)-alkyllamino, [(C₁-C₄)-alkoxylcarbonyl, [(C₁-C₄)-haloalkoxylcarbonyl, (C₃-C₆)-cycloalkyl which is unsubstituted or substituted, phenyl which is unsubstituted or substituted, and heterocyclyl which is unsubstituted or substituted,

or (C₃-C₆)-cycloalkyl, (C₄-C₆)-cycloalkenyl, (C₃-C₆)-cycloalkyl fused on one side of the ring to a 4- to 6-membered saturated or unsaturated carbocyclic ring, or (C₄-C₆)-cycloalkenyl fused on one side of the ring to a 4- to 6-membered saturated or unsaturated carbocyclic ring,

where each of the 4 last-mentioned radicals is unsubstituted or substituted by one or more radicals from the group of halogen, hydroxy, cyano, (C₁-C₄)-alkyl, (C₁-C₄)-haloalkyl, (C₁-C₄)-alkoxy, (C₁-C₄)-haloalkoxy, (C₁-C₄)-alkylthio, (C₁-C₄)-alkylamino, di[(C₁-C₄)-alkyl]amino, [(C₁-C₄)-alkoxylcarbonyl, [(C₁-C₄)-haloalkoxylcarbonyl, (C₃-C₆)-cycloalkyl which is unsubstituted or substituted, phenyl which is unsubstituted or substituted, and heterocyclyl which is unsubstituted or substituted, or R_{H}³ and R_{H}⁴ together with the directly bonded nitrogen atom a four- to eight-membered heterocyclic ring which, in addition to the nitrogen atom, may also contain further ring heteroatoms, preferably up to two further ring heteroatoms from the group of N, O and S, and which is unsubstituted or substituted by one or more radicals from the group of halogen, cyano, nitro, (C₁-C₄)-alkyl, (C₁-C₄)-haloalkyl, (C₁-C₄)-alkoxy, (C₁-C₄)-haloalkoxy and (C₁-C₄)-alkylthio.

The documents cited contain detailed information regarding preparation processes and starting materials, and name preferred compounds. These documents are explicitly incorporated by reference into this description.

Of particular significance are the safeners S1-1, S1-7, S1-11, S2-1, S3-1, S3-2, S3-4, S3-7, S3-8, S3-10, S3-11, S4-1, S4-5, S4-6, S11-1, S11-2, S11-3, S13-1, S13-2, S13-3, S13-8, S14-1, S14-2 and S14-3.

Examples of preferred herbicide safener compositions of herbicides (A) and safeners (B) are given in the following overview:

(A4-1)+(S1-1), (A4-1)+(S1-7), (A4-1)+(S1-11), (A4-1)+(S2-1), (A4-1)+(S3-1), (A4-1)+(S3-2), (A4-1)+(S3-4), (A4-1)+(S3-7), (A4-1)+(S3-8), (A4-1)+(S3-10), (A4-1)+(S3-11), (A4-1)+(S4-1), (A4-1)+(S4-5), (A4-1)+(S4-6), (A4-1)+(S11-1), (A4-1)+(S11-2), (A4-1)+(S11-3), (A4-1)+(S13-1), (A4-1)+(S13-2), (A4-1)+(S13-3), (A4-1)+(S13-8), (A4-1)+(S14-1), (A4-1)+(S14-2), (A4-1)+(S14-3), (A4-2)+(S1-1), (A4-2)+(S1-7), (A4-2)+(S1-11), (A4-2)+(S2-1), (A4-2)+(S3-1), (A4-2)+(S3-2), (A4-2)+(S3-4), (A4-2)+(S3-7), (A4-2)+(S3-8), (A4-2)+(S3-10), (A4-2)+(S3-11), (A4-2)+(S4-1), (A4-2)+(S4-5), (A4-2)+(S4-6), (A4-2)+(S11-1), (A4-2)+(S11-2), (A4-2)+(S11-3), (A4-2)+(S13-1), (A4-2)+(S13-2), (A4-2)+(S13-3), (A4-2)+(S13-8), (A4-2)+(S14-1), (A4-2)+(S14-2), (A4-2)+(S14-3), (A4-3)+(S1-1), (A4-3)+(S1-7), (A4-3)+(S1-11), (A4-3)+(S2-1), (A4-3)+(S3-1), (A4-3)+(S3-2), (A4-3)+(S3-4), (A4-3)+(S3-7), (A4-3)+(S3-8), (A4-3)+(S3-10), (A4-3)+(S3-11), (A4-3)+(S4-1), (A4-3)+(S4-5), (A4-3)+(S4-6), (A4-3)+(S11-1), (A4-3)+(S11-2), (A4-3)+(S11-3), (A4-3)+(S13-1), (A4-3)+(S13-2), (A4-3)+(S13-3), (A4-3)+(S13-8), (A4-3)+(S14-1), (A4-3)+(S14-2), (A4-3)+(S14-3), (A4-4)+(S1-1), (A4-4)+(S1-7), (A4-4)+(S1-11), (A4-4)+(S2-1), (A4-4)+(S3-1), (A4-4)+(S3-2), (A4-4)+(S3-4), (A4-4)+(S3-7), (A4-4)+(S3-8), (A4-4)+(S3-10), (A4-4)+(S3-11), (A4-4)+(S4-1), (A4-4)+(S4-5), (A4-4)+(S4-6), (A4-4)+(S11-1), (A4-4)+(S11-2), (A4-4)+(S11-3), (A4-4)+(S13-1), (A4-4)+(S13-2), (A4-4)+(S13-3), (A4-4)+(S13-8), (A4-4)+(S14-1), (A4-4)+(S14-2), (A4-4)+(S14-3), (A4-5)+(S1-1), (A4-5)+(S1-7), (A4-5)+(S1-11), (A4-5)+(S2-1), (A4-5)+(S3-1), (A4-5)+(S3-2), (A4-5)+(S3-4), (A4-5)+(S3-7), (A4-5)+(S3-8), (A4-5)+(S3-10), (A4-5)+(S3-11), (A4-5)+(S4-1), (A4-5)+(S4-5), (A4-5)+(S4-6), (A4-5)+(S11-1), (A4-5)+(S11-2), (A4-5)+(S11-3), (A4-5)+(S13-1), (A4-5)+(S13-2), (A4-5)+(S13-3), (A4-5)+(S13-8), (A4-5)+(S14-1), (A4-5)+(S14-2), (A4-5)+(S14-3), (A4-6)+(S1-1), (A4-6)+(S1-7), (A4-6)+(S1-11), (A4-6)+(S2-1), (A4-6)+(S3-1), (A4-6)+(S3-2), (A4-6)+(S3-4), (A4-6)+(S3-7), (A4-6)+(S3-8), (A4-6)+(S3-10), (A4-6)+(S3-11), (A4-6)+(S4-1), (A4-6)+(S4-5), (A4-6)+(S4-6), (A4-6)+(S11-1), (A4-6)+(S11-2), (A4-6)+(S11-3), (A4-6)+(S13-1), (A4-6)+(S13-2), (A4-6)+(S13-3), (A4-6)+(S13-8), (A4-6)+(S14-1), (A4-6)+(S14-2), (A4-6)+(S14-3), (A4-7)+(S1-1), (A4-7)+(S1-7), (A4-7)+(S1-11), (A4-7)+(S2-1), (A4-7)+(S3-1), (A4-7)+(S3-2), (A4-7)+(S3-4), (A4-7)+(S3-7), (A4-7)+(S3-8), (A4-7)+(S3-10), (A4-7)+(S3-11), (A4-7)+(S4-1), (A4-7)+(S4-5), (A4-7)+(S4-6), (A4-7)+(S11-1), (A4-7)+(S11-2), (A4-7)+(S11-3), (A4-7)+(S13-1), (A4-7)+(S13-2), (A4-7)+(S13-3), (A4-7)+(S13-8), (A4-7)+(S14-1), (A4-7)+(S14-2), (A4-7)+(S14-3), (A4-8)+(S1-1), (A4-8)+(S1-7), (A4-8)+(S1-11), (A4-8)+(S2-1), (A4-8)+(S3-1), (A4-8)+(S3-2), (A4-8)+(S3-4), (A4-8)+(S3-7), (A4-8)+(S3-8), (A4-8)+(S3-10), (A4-8)+(S3-11), (A4-8)+(S4-1), (A4-8)+(S4-5), (A4-8)+(S4-6), (A4-8)+(S11-1), (A4-8)+(S11-2), (A4-8)+(S11-3), (A4-8)+(S13-1), (A4-8)+(S13-2), (A4-8)+(S13-3), (A4-8)+(S13-8), (A4-8)+(S14-1), (A4-8)+(S14-2), (A4-8)+(S14-3), (A4-9)+(S1-1), (A4-9)+(S1-7), (A4-9)+(S1-11), (A4-9)+(S2-1), (A4-9)+(S3-1), (A4-9)+(S3-2), (A4-9)+(S3-4), (A4-9)+(S3-7), (A4-9)+(S3-8), (A4-9)+(S3-10), (A4-9)+(S3-11), (A4-9)+(S4-1), (A4-9)+(S4-5), (A4-9)+(S4-6), (A4-9)+(S11-1), (A4-9)+(S11-2), (A4-9)+(S11-3), (A4-9)+(S13-1), (A4-9)+(S13-2), (A4-9)+(S13-3), (A4-9)+(S13-8), (A4-9)+(S14-1), (A4-9)+(S14-2), (A4-9)+(S14-3), (A4-10)+(S1-1), (A4-10)+(S1-7), (A4-10)+(S1-11), (A4-10)+(S2-1), (A4-10)+(S3-1), (A4-10)+(S3-2), (A4-10)+(S3-4), (A4-10)+(S3-7), (A4-10)+(S3-8), (A4-10)+(S3-10), (A4-10)+(S3-11), (A4-10)+(S4-1), (A4-10)+(S4-5), (A4-10)+(S4-6), (A4-10)+(S11-1), (A4-10)+(S11-2), (A4-10)+(S11-3), (A4- 10)+(S13-1), (A4-10)+(S13-2), (A4-10)+(S13-3), (A4-10)+(S13-8), (A4-10)+(S14-1), (A4-10)+(S14-2), (A4-10)+(S14-3),

(A4-11)+(S1-1), (A4-11)+(S1-7), (A4-11)+(S1-11), (A4-11)+(S2-1), (A4-11)+(S3-1), (A4- 11)+(S3-2), (A4-11)+(S3-4), (A4-11)+(S3-7), (A4-11)+(S3-8), (A4-11)+(S3-10), (A4-11)+(S3-11), (A4-11)+(S4-1), (A4-11)+(S4-5), (A4-11)+(S4-6), (A4-11)+(S11-1), (A4-11)+(S11-2), (A4-11)+(S11-3), (A4- 11)+(S13-1), (A4-11)+(S13-2), (A4-11)+(S13-3), (A4-11)+(S13-8), (A4-11)+(S14-1), (A4-11)+(S14-2), (A4-11)+(S14-3),

(A4-12)+(S1-1), (A4-12)+(S1-7), (A4-12)+(S1-11), (A4-12)+(S2-1), (A4-12)+(S3-1), (A4- 12)+(S3-2), (A4-12)+(S3-4), (A4-12)+(S3-7), (A4-12)+(S3-8), (A4-12)+(S3-10), (A4-12)+(S3-11), (A4-12)+(S4-1), (A4-12)+(S4-5), (A4-12)+(S4-6), (A4-12)+(S11-1), (A4-12)+(S11-2), (A4-12)+(S11-3), (A4- 12)+(S13-1), (A4-12)+(S13-2), (A4-12)+(S13-3), (A4-12)+(S13-8), (A4-12)+(S14-1), (A4-12)+(S14-2), (A4-12)+(S14-3),

(A4-13)+(S1-1), (A4-13)+(S1-7), (A4-13)+(S1-11), (A4-13)+(S2-1), (A4-13)+(S3-1), (A4- 13)+(S3-2), (A4-13)+(S3-4), (A4-13)+(S3-7), (A4-13)+(S3-8), (A4-13)+(S3-10), (A4-13)+(S3-11), (A4-13)+(S4-1), (A4-13)+(S4-5), (A4-13)+(S4-6), (A4-13)+(S11-1), (A4-13)+(S11-2), (A4-13)+(S11-3), (A4- 13)+(S13-1), (A4-13)+(S13-2), (A4-13)+(S13-3), (A4-13)+(S13-8), (A4-13)+(S14-1), (A4-13)+(S14-2), (A4-13)+(S14-3),

(A4-14)+(S1-1), (A4-14)+(S1-7), (A4-14)+(S1-11), (A4-14)+(S2-1), (A4-14)+(S3-1), (A4- 14)+(S3-2), (A4-14)+(S3-4), (A4-14)+(S3-7), (A4-14)+(S3-8), (A4-14)+(S3-10), (A4-14)+(S3-11), (A4-14)+(S4-1), (A4-14)+(S4-5), (A4-14)+(S4-6), (A4-14)+(S11-1), (A4-14)+(S11-2), (A4-14)+(S11-3), (A4- 14)+(S13-1), (A4-14)+(S13-2), (A4-14)+(S13-3), (A4-14)+(S13-8), (A4-14)+(S14-1), (A4-14)+(S14-2), (A4-14)+(S14-3),

(A4-15)+(S1-1), (A4-15)+(S1-7), (A4-15)+(S1-11), (A4-15)+(S2-1), (A4-15)+(S3-1), (A4- 15)+(S3-2), (A4-15)+(S3-4), (A4-15)+(S3-7), (A4-15)+(S3-8), (A4-15)+(S3-10), (A4-15)+(S3-11), (A4-15)+(S4-1), (A4-15)+(S4-5), (A4-15)+(S4-6), (A4-15)+(S11-1), (A4-15)+(S11-2), (A4-15)+(S11-3), (A4- 15)+(S13-1), (A4-15)+(S13-2), (A4-15)+(S13-3), (A4-15)+(S13-8), (A4-15)+(S14-1), (A4-15)+(S14-2), (A4-15)+(S14-3),

(A4-16)+(S1-1), (A4-16)+(S1-7), (A4-16)+(S1-11), (A4-16)+(S2-1), (A4-16)+(S3-1), (A4- 16)+(S3-2), (A4-16)+(S3-4), (A4-16)+(S3-7), (A4-16)+(S3-8), (A4-16)+(S3-10), (A4-16)+(S3-11), (A4-16)+(S4-1), (A4-16)+(S4-5), (A4-16)+(S4-6), (A4-16)+(S11-1), (A4-16)+(S11-2), (A4-16)+(S11-3), (A4- 16)+(S13-1), (A4-16)+(S13-2), (A4-16)+(S13-3), (A4-16)+(S13-8), (A4-16)+(S14-1), (A4-16)+(S14-2), (A4-16)+(S14-3),

(A4-17)+(S1-1), (A4-17)+(S1-7), (A4-17)+(S1-11), (A4-17)+(S2-1), (A4-17)+(S3-1), (A4- 17)+(S3-2), (A4-17)+(S3-4), (A4-17)+(S3-7), (A4-17)+(S3-8), (A4-17)+(S3-10), (A4-17)+(S3-11), (A4-17)+(S4-1), (A4-17)+(S4-5), (A4-17)+(S4-6), (A4-17)+(S11-1), (A4-17)+(S11-2), (A4-17)+(S11-3), (A4- 17)+(S13-1), (A4-17)+(S13-2), (A4-17)+(S13-3), (A4-17)+(S13-8), (A4-17)+(S14-1), (A4-17)+(S14-2), (A4-17)+(S14-3),

(A4-18)+(S1-1), (A4-18)+(S1-7), (A4-18)+(S1-11), (A4-18)+(S2-1), (A4-18)+(S3-1), (A4- 18)+(S3-2), (A4-18)+(S3-4), (A4-18)+(S3-7), (A4-18)+(S3-8), (A4-18)+(S3-10), (A4-18)+(S3-11), (A4-18)+(S4-1), (A4-18)+(S4-5), (A4-18)+(S4-6), (A4-18)+(S11-1), (A4-18)+(S11-2), (A4-18)+(S11-3), (A4- 18)+(S13-1), (A4-18)+(S13-2), (A4-18)+(S13-3), (A4-18)+(S13-8), (A4-18)+(S14-1), (A4-18)+(S14-2), (A4-18)+(S14-3),

(A4-19)+(S1-1), (A4-19)+(S1-7), (A4-19)+(S1-11), (A4-19)+(S2-1), (A4-19)+(S3-1), (A4- 19)+(S3-2), (A4-19)+(S3-4), (A4-19)+(S3-7), (A4-19)+(S3-8), (A4-19)+(S3-10), (A4-19)+(S3-11), (A4-19)+(S4-1), (A4-19)+(S4-5), (A4-19)+(S4-6), (A4-19)+(S11-1), (A4-19)+(S11-2), (A4-19)+(S11-3), (A4- 19)+(S13-1), (A4-19)+(S13-2), (A4-19)+(S13-3), (A4-19)+(S13-8), (A4-19)+(S14-1), (A4-19)+(S14-2), (A4-19)+(S14-3),

(A4-20)+(S1-1), (A4-20)+(S1-7), (A4-20)+(S1-11), (A4-20)+(S2-1), (A4-20)+(S3-1), (A4- 20)+(S3-2), (A4-20)+(S3-4), (A4-20)+(S3-7), (A4-20)+(S3-8), (A4-20)+(S3-10), (A4-20)+(S3-11), (A4-20)+(S4-1), (A4-20)+(S4-5), (A4-20)+(S4-6), (A4-20)+(S11-1), (A4-20)+(S11-2), (A4-20)+(S11-3), (A4- 20)+(S13-1), (A4-20)+(S13-2), (A4-20)+(S13-3), (A4-20)+(S13-8), (A4-20)+(S14-1), (A4-20)+(S14-2), (A4-20)+(S14-3),

(A4-21)+(S1-1), (A4-21)+(S1-7), (A4-21)+(S1-11), (A4-21)+(S2-1), (A4-21)+(S3-1), (A4- 21)+(S3-2), (A4-21)+(S3-4), (A4-21)+(S3-7), (A4-21)+(S3-8), (A4-21)+(S3-10), (A4-21)+(S3-11), (A4-21)+(S4-1), (A4-21)+(S4-5), (A4-21)+(S4-6), (A4-21)+(S11-1), (A4-21)+(S11-2), (A4-21)+(S11-3), (A4- 21)+(S13-1), (A4-21)+(S13-2), (A4-21)+(S13-3), (A4-21)+(S13-8), (A4-21)+(S14-1), (A4-21)+(S14-2), (A4-21)+(S14-3),

(A4-22)+(S1-1), (A4-22)+(S1-7), (A4-22)+(S1-11), (A4-22)+(S2-1), (A4-22)+(S3-1), (A4- 22)+(S3-2), (A4-22)+(S3-4), (A4-22)+(S3-7), (A4-22)+(S3-8), (A4-22)+(S3-10), (A4-22)+(S3-11), (A4-22)+(S4-1), (A4-22)+(S4-5), (A4-22)+(S4-6), (A4-22)+(S11-1), (A4-22)+(S11-2), (A4-22)+(S11-3), (A4- 22)+(S13-1), (A4-22)+(S13-2), (A4-22)+(S13-3), (A4-22)+(S13-8), (A4-22)+(S14-1), (A4-22)+(S14-2), (A4-22)+(S14-3),

(A4-23)+(S1-1), (A4-23)+(S1-7), (A4-23)+(S1-11), (A4-23)+(S2-1), (A4-23)+(S3-1), (A4- 23)+(S3-2), (A4-23)+(S3-4), (A4-23)+(S3-7), (A4-23)+(S3-8), (A4-23)+(S3-10), (A4-23)+(S3-11), (A4-23)+(S4-1), (A4-23)+(S4-5), (A4-23)+(S4-6), (A4-23)+(S11-1), (A4-23)+(S11-2), (A4-23)+(S11-3), (A4- 23)+(S13-1), (A4-23)+(S13-2), (A4-23)+(S13-3), (A4-23)+(S13-8), (A4-23)+(S14-1), (A4-23)+(S14-2), (A4-23)+(S14-3),

(A4-24)+(S1-1), (A4-24)+(S1-7), (A4-24)+(S1-11), (A4-24)+(S2-1), (A4-24)+(S3-1), (A4- 24)+(S3-2), (A4-24)+(S3-4), (A4-24)+(S3-7), (A4-24)+(S3-8), (A4-24)+(S3-10), (A4-24)+(S3-11), (A4-24)+(S4-1), (A4-24)+(S4-5), (A4-24)+(S4-6), (A4-24)+(S11-1), (A4-24)+(S11-2), (A4-24)+(S11-3), (A4- 24)+(S13-1), (A4-24)+(S13-2), (A4-24)+(S13-3), (A4-24)+(S13-8), (A4-24)+(S14-1), (A4-24)+(S14-2), (A4-24)+(S14-3),

(A4-25)+(S1-1), (A4-25)+(S1-7), (A4-25)+(S1-11), (A4-25)+(S2-1), (A4-25)+(S3-1), (A4- 25)+(S3-2), (A4-25)+(S3-4), (A4-25)+(S3-7), (A4-25)+(S3-8), (A4-25)+(S3-10), (A4-25)+(S3-11), (A4-25)+(S4-1), (A4-25)+(S4-5), (A4-25)+(S4-6), (A4-25)+(S11-1), (A4-25)+(S11-2), (A4-25)+(S11-3), (A4- 25)+(S13-1), (A4-25)+(S13-2), (A4-25)+(S13-3), (A4-25)+(S13-8), (A4-25)+(S14-1), (A4-25)+(S14-2), (A4-25)+(S14-3),

(A4-26)+(S1-1), (A4-26)+(S1-7), (A4-26)+(S1-11), (A4-26)+(S2-1), (A4-26)+(S3-1), (A4- 26)+(S3-2), (A4-26)+(S3-4), (A4-26)+(S3-7), (A4-26)+(S3-8), (A4-26)+(S3-10), (A4-26)+(S3-11), (A4-26)+(S4-1), (A4-26)+(S4-5), (A4-26)+(S4-6), (A4-26)+(S11-1), (A4-26)+(S11-2), (A4-26)+(S11-3), (A4- 26)+(S13-1), (A4-26)+(S13-2), (A4-26)+(S13-3), (A4-26)+(S13-8), (A4-26)+(S14-1), (A4-26)+(S14-2), (A4-26)+(S14-3),

(A4-27)+(S1-1), (A4-27)+(S1-7), (A4-27)+(S1-11), (A4-27)+(S2-1), (A4-27)+(S3-1), (A4- 27)+(S3-2), (A4-27)+(S3-4), (A4-27)+(S3-7), (A4-27)+(S3-8), (A4-27)+(S3-10), (A4-27)+(S3-11), (A4-27)+(S4-1), (A4-27)+(S4-5), (A4-27)+(S4-6), (A4-27)+(S11-1), (A4-27)+(S11-2), (A4-27)+(S11-3), (A4- 27)+(S13-1), (A4-27)+(S13-2), (A4-27)+(S13-3), (A4-27)+(S13-8), (A4-27)+(S14-1), (A4-27)+(S14-2), (A4-27)+(S14-3),

(A4-28)+(S1-1), (A4-28)+(S1-7), (A4-28)+(S1-11), (A4-28)+(S2-1), (A4-28)+(S3-1), (A4- 28)+(S3-2), (A4-28)+(S3-4), (A4-28)+(S3-7), (A4-28)+(S3-8), (A4-28)+(S3-10), (A4-28)+(S3-11), (A4-28)+(S4-1), (A4-28)+(S4-5), (A4-28)+(S4-6), (A4-28)+(S11-1), (A4-28)+(S11-2), (A4-28)+(S11-3), (A4- 28)+(S13-1), (A4-28)+(S13-2), (A4-28)+(S13-3), (A4-28)+(S13-8), (A4-28)+(S14-1), (A4-28)+(S14-2), (A4-28)+(S14-3),

(A4-29)+(S1-1), (A4-29)+(S1-7), (A4-29)+(S1-11), (A4-29)+(S2-1), (A4-29)+(S3-1), (A4- 29)+(S3-2), (A4-29)+(S3-4), (A4-29)+(S3-7), (A4-29)+(S3-8), (A4-29)+(S3-10), (A4-29)+(S3-11), (A4-29)+(S4-1), (A4-29)+(S4-5), (A4-29)+(S4-6), (A4-29)+(S11-1), (A4-29)+(S11-2), (A4-29)+(S11-3), (A4- 29)+(S13-1), (A4-29)+(S13-2), (A4-29)+(S13-3), (A4-29)+(S13-8), (A4-29)+(S14-1), (A4-29)+(S14-2), (A4-29)+(S14-3),

(A4-30)+(S1-1), (A4-30)+(S1-7), (A4-30)+(S1-11), (A4-30)+(S2-1), (A4-30)+(S3-1), (A4- 30)+(S3-2), (A4-30)+(S3-4), (A4-30)+(S3-7), (A4-30)+(S3-8), (A4-30)+(S3-10), (A4-30)+(S3-11), (A4-30)+(S4-1), (A4-30)+(S4-5), (A4-30)+(S4-6), (A4-30)+(S11-1), (A4-30)+(S11-2), (A4-30)+(S11-3), (A4- 30)+(S13-1), (A4-30)+(S13-2), (A4-30)+(S13-3), (A4-30)+(S13-8), (A4-30)+(S14-1), (A4-30)+(S14-2), (A4-30)+(S14-3),

(A4-31)+(S1-1), (A4-31)+(S1-7), (A4-31)+(S1-11), (A4-31)+(S2-1), (A4-31)+(S3-1), (A4- 31)+(S3-2), (A4-31)+(S3-4), (A4-31)+(S3-7), (A4-31)+(S3-8), (A4-31)+(S3-10), (A4-31)+(S3-11), (A4-31)+(S4-1), (A4-31)+(S4-5), (A4-31)+(S4-6), (A4-31)+(S11-1), (A4-31)+(S11-2), (A4-31)+(S11-3), (A4- 31)+(S13-1), (A4-31)+(S13-2), (A4-31)+(S13-3), (A4-31)+(S13-8), (A4-31)+(S14-1), (A4-31)+(S14-2), (A4-31)+(S14-3),

(A4-32)+(S1-1), (A4-32)+(S1-7), (A4-32)+(S1-11), (A4-32)+(S2-1), (A4-32)+(S3-1), (A4- 32)+(S3-2), (A4-32)+(S3-4), (A4-32)+(S3-7), (A4-32)+(S3-8), (A4-32)+(S3-10), (A4-32)+(S3-11), (A4-32)+(S4-1), (A4-32)+(S4-5), (A4-32)+(S4-6), (A4-32)+(S11-1), (A4-32)+(S11-2), (A4-32)+(S11-3), (A4- 32)+(S13-1), (A4-32)+(S13-2), (A4-32)+(S13-3), (A4-32)+(S13-8), (A4-32)+(S14-1), (A4-32)+(S14-2), (A4-32)+(S14-3),

(A4-33)+(S1-1), (A4-33)+(S1-7), (A4-33)+(S1-11), (A4-33)+(S2-1), (A4-33)+(S3-1), (A4- 33)+(S3-2), (A4-33)+(S3-4), (A4-33)+(S3-7), (A4-33)+(S3-8), (A4-33)+(S3-10), (A4-33)+(S3-11), (A4-33)+(S4-1), (A4-33)+(S4-5), (A4-33)+(S4-6), (A4-33)+(S11-1), (A4-33)+(S11-2), (A4-33)+(S11-3), (A4- 33)+(S13-1), (A4-33)+(S13-2), (A4-33)+(S13-3), (A4-33)+(S13-8), (A4-33)+(S14-1), (A4-33)+(S14-2), (A4-33)+(S14-3),

(A4-34)+(S1-1), (A4-34)+(S1-7), (A4-34)+(S1-11), (A4-34)+(S2-1), (A4-34)+(S3-1), (A4- 34)+(S3-2), (A4-34)+(S3-4), (A4-34)+(S3-7), (A4-34)+(S3-8), (A4-34)+(S3-10), (A4-34)+(S3-11), (A4-34)+(S4-1), (A4-34)+(S4-5), (A4-34)+(S4-6), (A4-34)+(S11-1), (A4-34)+(S11-2), (A4-34)+(S11-3), (A4- 34)+(S13-1), (A4-34)+(S13-2), (A4-34)+(S13-3), (A4-34)+(S13-8), (A4-34)+(S14-1), (A4-34)+(S14-2), (A4-34)+(S14-3),

(A4-35)+(S1-1), (A4-35)+(S1-7), (A4-35)+(S1-11), (A4-35)+(S2-1), (A4-35)+(S3-1), (A4- 35)+(S3-2), (A4-35)+(S3-4), (A4-35)+(S3-7), (A4-35)+(S3-8), (A4-35)+(S3-10), (A4-35)+(S3-11), (A4-35)+(S4-1), (A4-35)+(S4-5), (A4-35)+(S4-6), (A4-35)+(S11-1), (A4-35)+(S11-2), (A4-35)+(S11-3), (A4- 35)+(S13-1), (A4-35)+(S13-2), (A4-35)+(S13-3), (A4-35)+(S13-8), (A4-35)+(S14-1), (A4-35)+(S14-2), (A4-35)+(S14-3),

(A4-36)+(S1-1), (A4-36)+(S1-7), (A4-36)+(S1-11), (A4-36)+(S2-1), (A4-36)+(S3-1), (A4- 36)+(S3-2), (A4-36)+(S3-4), (A4-36)+(S3-7), (A4-36)+(S3-8), (A4-36)+(S3-10), (A4-36)+(S3-11), (A4-36)+(S4-1), (A4-36)+(S4-5), (A4-36)+(S4-6), (A4-36)+(S11-1), (A4-36)+(S11-2), (A4-36)+(S11-3), (A4- 36)+(S13-1), (A4-36)+(S13-2), (A4-36)+(S13-3), (A4-36)+(S13-8), (A4-36)+(S14-1), (A4-36)+(S14-2), (A4-36)+(S14-3),

(A5-1)+(S1-1), (A5-1)+(S1-7), (A5-1)+(S1-11), (A5-1)+(S2-1), (A5-1)+(S3-1), (A5-1)+(S3-2), (A5-1)+(S3-4), (A5-1)+(S3-7), (A5-1)+(S3-8), (A5-1)+(S3-10), (A5-1)+(S3-11), (A5-1)+(S4-1), (A5-1)+(S4-5), (A5-1)+(S4-6), (A5-1)+(S11-1), (A5-1)+(S11-2), (A5-1)+(S11-3), (A5-1)+(S13-1), (A5-1)+(S13-2), (A5-1)+(S13-3), (A5-1)+(S13-8), (A5-1)+(S14-1), (A5-1)+(S14-2), (A5-1)+(S14-3), (A5-2)+(S1-1), (A5-2)+(S1-7), (A5-2)+(S1-11), (A5-2)+(S2-1), (A5-2)+(S3-1), (A5-2)+(S3-2), (A5-2)+(S3-4), (A5-2)+(S3-7), (A5-2)+(S3-8), (A5-2)+(S3-10), (A5-2)+(S3-11), (A5-2)+(S4-1), (A5-2)+(S4-5), (A5-2)+(S4-6), (A5-2)+(S11-1), (A5-2)+(S11-2), (A5-2)+(S11-3), (A5-2)+(S13-1), (A5-2)+(S13-2), (A5-2)+(S13-3), (A5-2)+(S13-8), (A5-2)+(S14-1), (A5-2)+(S14-2), (A5-2)+(S14-3), (A5-3)+(S1-1), (A5-3)+(S1-7), (A5-3)+(S1-11), (A5-3)+(S2-1), (A5-3)+(S3-1), (A5-3)+(S3-2), (A5-3)+(S3-4), (A5-3)+(S3-7), (A5-3)+(S3-8), (A5-3)+(S3-10), (A5-3)+(S3-11), (A5-3)+(S4-1), (A5-3)+(S4-5), (A5-3)+(S4-6), (A5-3)+(S11-1), (A5-3)+(S11-2), (A5-3)+(S11-3), (A5-3)+(S13-1), (A5-3)+(S13-2), (A5-3)+(S13-3), (A5-3)+(S13-8), (A5-3)+(S14-1), (A5-3)+(S14-2), (A5-3)+(S14-3), (A5-4)+(S1-1), (A5-4)+(S1-7), (A5-4)+(S1-11), (A5-4)+(S2-1), (A5-4)+(S3-1), (A5-4)+(S3-2), (A5-4)+(S3-4), (A5-4)+(S3-7), (A5-4)+(S3-8), (A5-4)+(S3-10), (A5-4)+(S3-11), (A5-4)+(S4-1), (A5-4)+(S4-5), (A5-4)+(S4-6), (A5-4)+(S11-1), (A5-4)+(S11-2), (A5-4)+(S11-3), (A5-4)+(S13-1), (A5-4)+(S13-2), (A5-4)+(S13-3), (A5-4)+(S13-8), (A5-4)+(S14-1), (A5-4)+(S14-2), (A5-4)+(S14-3), (A5-5)+(S1-1), (A5-5)+(S1-7), (A5-5)+(S1-11), (A5-5)+(S2-1), (A5-5)+(S3-1), (A5-5)+(S3-2), (A5-5)+(S3-4), (A5-5)+(S3-7), (A5-5)+(S3-8), (A5-5)+(S3-10), (A5-5)+(S3-11), (A5-5)+(S4-1), (A5-5)+(S4-5), (A5-5)+(S4-6), (A5-5)+(S11-1), (A5-5)+(S11-2), (A5-5)+(S11-3), (A5-5)+(S13-1), (A5-5)+(S13-2), (A5-5)+(S13-3), (A5-5)+(S13-8), (A5-5)+(S14-1), (A5-5)+(S14-2), (A5-5)+(S14-3), (A5-6)+(S1-1), (A5-6)+(S1-7), (A5-6)+(S1-11), (A5-6)+(S2-1), (A5-6)+(S3-1), (A5-6)+(S3-2), (A5-6)+(S3-4), (A5-6)+(S3-7), (A5-6)+(S3-8), (A5-6)+(S3-10), (A5-6)+(S3-11), (A5-6)+(S4-1), (A5-6)+(S4-5), (A5-6)+(S4-6), (A5-6)+(S11-1), (A5-6)+(S11-2), (A5-6)+(S11-3), (A5-6)+(S13-1), (A5-6)+(S13-2), (A5-6)+(S13-3), (A5-6)+(S13-8), (A5-6)+(S14-1), (A5-6)+(S14-2), (A5-6)+(S14-3), (A5-7)+(S1-1), (A5-7)+(S1-7), (A5-7)+(S1-11), (A5-7)+(S2-1), (A5-7)+(S3-1), (A5-7)+(S3-2), (A5-7)+(S3-4), (A5-7)+(S3-7), (A5-7)+(S3-8), (A5-7)+(S3-10), (A5-7)+(S3-11), (A5-7)+(S4-1), (A5-7)+(S4-5), (A5-7)+(S4-6), (A5-7)+(S11-1), (A5-7)+(S11-2), (A5-7)+(S11-3), (A5-7)+(S13-1), (A5-7)+(S13-2), (A5-7)+(S13-3), (A5-7)+(S13-8), (A5-7)+(S14-1), (A5-7)+(S14-2), (A5-7)+(S14-3), (A5-8)+(S1-1), (A5-8)+(S1-7), (A5-8)+(S1-11), (A5-8)+(S2-1), (A5-8)+(S3-1), (A5-8)+(S3-2), (A5-8)+(S3-4), (A5-8)+(S3-7), (A5-8)+(S3-8), (A5-8)+(S3-10), (A5-8)+(S3-11), (A5-8)+(S4-1), (A5-8)+(S4-5), (A5-8)+(S4-6), (A5-8)+(S11-1), (A5-8)+(S11-2), (A5-8)+(S11-3), (A5-8)+(S13-1), (A5-8)+(S13-2), (A5-8)+(S13-3), (A5-8)+(S13-8), (A5-8)+(S14-1), (A5-8)+(S14-2), (A5-8)+(S14-3), (A5-9)+(S1-1), (A5-9)+(S1-7), (A5-9)+(S1-11), (A5-9)+(S2-1), (A5-9)+(S3-1), (A5-9)+(S3-2), (A5-9)+(S3-4), (A5-9)+(S3-7), (A5-9)+(S3-8), (A5-9)+(S3-10), (A5-9)+(S3-11), (A5-9)+(S4-1), (A5-9)+(S4-5), (A5-9)+(S4-6), (A5-9)+(S11-1), (A5-9)+(S11-2), (A5-9)+(S11-3), (A5-9)+(S13-1), (A5-9)+(S13-2), (A5-9)+(S13-3), (A5-9)+(S13-8), (A5-9)+(S14-1), (A5-9)+(S14-2), (A5-9)+(S14-3), (A5-10)+(S1-1), (A5-10)+(S1-7), (A5-10)+(S1-11), (A5-10)+(S2-1), (A5-10)+(S3-1), (A5-10)+(S3-2), (A5-10)+(S3-4), (A5-10)+(S3-7), (A5-10)+(S3-8), (A5-10)+(S3-10), (A5-10)+(S3-11), (A5-10)+(S4-1), (A5-10)+(S4-5), (A5-10)+(S4-6), (A5-10)+(S11-1), (A5-10)+(S11-2), (A5-10)+(S11-3), (A5- 10)+(S13-1), (A5-10)+(S13-2), (A5-10)+(S13-3), (A5-10)+(S13-8), (A5-10)+(S14-1), (A5-10)+(S14-2), (A5-10)+(S14-3),

(A5-11)+(S1-1), (A5-11)+(S1-7), (A5-11)+(S1-11), (A5-11)+(S2-1), (A5-11)+(S3-1), (A5- 11)+(S3-2), (A5-11)+(S3-4), (A5-11)+(S3-7), (A5-11)+(S3-8), (A5-11)+(S3-10), (A5-11)+(S3-11), (A5-11)+(S4-1), (A5-11)+(S4-5), (A5-11)+(S4-6), (A5-11)±(S11-1), (A5-11)+(S11-2), (A5-11)±(S11-3), (A5- 11)+(S13-1), (A5-11)+(S13-2), (A5-11)+(S13-3), (A5-11)+(S13-8), (A5-11)+(S14-1), (A5-11)+(S14-2), (A5-11)+(S14-3),

(A5-12)+(S1-1), (A5-12)+(S1-7), (A5-12)+(S1-11), (A5-12)+(S2-1), (A5-12)+(S3-1), (A5- 12)+(S3-2), (A5-12)+(S3-4), (A5-12)+(S3-7), (A5-12)+(S3-8), (A5-12)+(S3-10), (A5-12)+(S3-11), (A5-12)+(S4-1), (A5-12)+(S4-5), (A5-12)+(S4-6), (A5-12)+(S11-1), (A5-12)+(S11-2), (A5-12)+(S11-3), (A5- 12)+(S13-1), (A5-12)+(S13-2), (A5-12)+(S13-3), (A5-12)+(S13-8), (A5-12)+(S14-1), (A5-12)+(S14-2), (A5-12)+(S14-3),

(A5-13)+(S1-1), (A5-13)+(S1-7), (A5-13)+(S1-11), (A5-13)+(S2-1), (A5-13)+(S3-1), (A5- 13)+(S3-2), (A5-13)+(S3-4), (A5-13)+(S3-7), (A5-13)+(S3-8), (A5-13)+(S3-10), (A5-13)+(S3-11), (A5-13)+(S4-1), (A5-13)+(S4-5), (A5-13)+(S4-6), (A5-13)+(S11-1), (A5-13)+(S11-2), (A5-13)+(S11-3), (A5- 13)+(S13-1), (A5-13)+(S13-2), (A5-13)+(S13-3), (A5-13)+(S13-8), (A5-13)+(S14-1), (A5-13)+(S14-2), (A5-13)+(S14-3),

(A5-14)+(S1-1), (A5-14)+(S1-7), (A5-14)+(S1-11), (A5-14)+(S2-1), (A5-14)+(S3-1), (A5- 14)+(S3-2), (A5-14)+(S3-4), (A5-14)+(S3-7), (A5-14)+(S3-8), (A5-14)+(S3-10), (A5-14)+(S3-11), (A5-14)+(S4-1), (A5-14)+(S4-5), (A5-14)+(S4-6), (A5-14)+(S11-1), (A5-14)+(S11-2), (A5-14)+(S11-3), (A5- 14)+(S13-1), (A5-14)+(S13-2), (A5-14)+(S13-3), (A5-14)+(S13-8), (A5-14)+(S14-1), (A5-14)+(S14-2), (A5-14)+(S14-3),

(A5-15)+(S1-1), (A5-15)+(S1-7), (A5-15)+(S1-11), (A5-15)+(S2-1), (A5-15)+(S3-1), (A5- 15)+(S3-2), (A5-15)+(S3-4), (A5-15)+(S3-7), (A5-15)+(S3-8), (A5-15)+(S3-10), (A5-15)+(S3-11), (A5-15)+(S4-1), (A5-15)+(S4-5), (A5-15)+(S4-6), (A5-15)+(S11-1), (A5-15)+(S11-2), (A5-15)+(S11-3), (A5- 15)+(S13-1), (A5-15)+(S13-2), (A5-15)+(S13-3), (A5-15)+(S13-8), (A5-15)+(S14-1), (A5-15)+(S14-2), (A5-15)+(S14-3),

(A5-16)+(S1-1), (A5-16)+(S1-7), (A5-16)+(S1-11), (A5-16)+(S2-1), (A5-16)+(S3-1), (A5- 16)+(S3-2), (A5-16)+(S3-4), (A5-16)+(S3-7), (A5-16)+(S3-8), (A5-16)+(S3-10), (A5-16)+(S3-11), (A5-16)+(S4-1), (A5-16)+(S4-5), (A5-16)+(S4-6), (A5-16)+(S11-1), (A5-16)+(S11-2), (A5-16)+(S11-3), (A5- 16)+(S13-1), (A5-16)+(S13-2), (A5-16)+(S13-3), (A5-16)+(S13-8), (A5-16)+(S14-1), (A5-16)+(S14-2), (A5-16)+(S14-3),

(A5-17)+(S1-1), (A5-17)+(S1-7), (A5-17)+(S1-11), (A5-17)+(S2-1), (A5-17)+(S3-1), (A5- 17)+(S3-2), (A5-17)+(S3-4), (A5-17)+(S3-7), (A5-17)+(S3-8), (A5-17)+(S3-10), (A5-17)+(S3-11), (A5-17)+(S4-1), (A5-17)+(S4-5), (A5-17)+(S4-6), (A5-17)+(S11-1), (A5-17)+(S11-2), (A5-17)+(S11-3), (A5- 17)+(S13-1), (A5-17)+(S13-2), (A5-17)+(S13-3), (A5-17)+(S13-8), (A5-17)+(S14-1), (A5-17)+(S14-2), (A5-17)+(S14-3),

(A5-18)+(S1-1), (A5-18)+(S1-7), (A5-18)+(S1-11), (A5-18)+(S2-1), (A5-18)+(S3-1), (A5- 18)+(S3-2), (A5-18)+(S3-4), (A5-18)+(S3-7), (A5-18)+(S3-8), (A5-18)+(S3-10), (A5-18)+(S3-11), (A5-18)+(S4-1), (A5-18)+(S4-5), (A5-18)+(S4-6), (A5-18)+(S11-1), (A5-18)+(S11-2), (A5-18)+(S11-3), (A5- 18)+(S13-1), (A5-18)+(S13-2), (A5-18)+(S13-3), (A5-18)+(S13-8), (A5-18)+(S14-1), (A5-18)+(S14-2), (A5-18)+(S14-3),

(A5-19)+(S1-1), (A5-19)+(S1-7), (A5-19)+(S1-11), (A5-19)+(S2-1), (A5-19)+(S3-1), (A5- 19)+(S3-2), (A5-19)+(S3-4), (A5-19)+(S3-7), (A5-19)+(S3-8), (A5-19)+(S3-10), (A5-19)+(S3-11), (A5-19)+(S4-1), (A5-19)+(S4-5), (A5-19)+(S4-6), (A5-19)+(S11-1), (A5-19)+(S11-2), (A5-19)+(S11-3), (A5- 19)+(S13-1), (A5-19)+(S13-2), (A5-19)+(S13-3), (A5-19)+(S13-8), (A5-19)+(S14-1), (A5-19)+(S14-2), (A5-19)+(S14-3),

(A5-20)+(S1-1), (A5-20)+(S1-7), (A5-20)+(S1-11), (A5-20)+(S2-1), (A5-20)+(S3-1), (A5- 20)+(S3-2), (A5-20)+(S3-4), (A5-20)+(S3-7), (A5-20)+(S3-8), (A5-20)+(S3-10), (A5-20)+(S3-11), (A5-20)+(S4-1), (A5-20)+(S4-5), (A5-20)+(S4-6), (A5-20)+(S11-1), (A5-20)+(S11-2), (A5-20)+(S11-3), (A5- 20)+(S13-1), (A5-20)+(S13-2), (A5-20)+(S13-3), (A5-20)+(S13-8), (A5-20)+(S14-1), (A5-20)+(S14-2), (A5-20)+(S14-3),

(A5-21)+(S1-1), (A5-21)+(S1-7), (A5-21)+(S1-11), (A5-21)+(S2-1), (A5-21)+(S3-1), (A5- 21)+(S3-2), (A5-21)+(S3-4), (A5-21)+(S3-7), (A5-21)+(S3-8), (A5-21)+(S3-10), (A5-21)+(S3-11), (A5-21)+(S4-1), (A5-21)+(S4-5), (A5-21)+(S4-6), (A5-21)+(S11-1), (A5-21)+(S11-2), (A5-21)+(S11-3), (A5- 21)+(S13-1), (A5-21)+(S13-2), (A5-21)+(S13-3), (A5-21)+(S13-8), (A5-21)+(S14-1), (A5-21)+(S14-2), (A5-21)+(S14-3),

(A5-22)+(S1-1), (A5-22)+(S1-7), (A5-22)+(S1-11), (A5-22)+(S2-1), (A5-22)+(S3-1), (A5- 22)+(S3-2), (A5-22)+(S3-4), (A5-22)+(S3-7), (A5-22)+(S3-8), (A5-22)+(S3-10), (A5-22)+(S3-11), (A5-22)+(S4-1), (A5-22)+(S4-5), (A5-22)+(S4-6), (A5-22)+(S11-1), (A5-22)+(S11-2), (A5-22)+(S11-3), (A5- 22)+(S13-1), (A5-22)+(S13-2), (A5-22)+(S13-3), (A5-22)+(S13-8), (A5-22)+(S14-1), (A5-22)+(S14-2), (A5-22)+(S14-3),

(A5-23)+(S1-1), (A5-23)+(S1-7), (A5-23)+(S1-11), (A5-23)+(S2-1), (A5-23)+(S3-1), (A5- 23)+(S3-2), (A5-23)+(S3-4), (A5-23)+(S3-7), (A5-23)+(S3-8), (A5-23)+(S3-10), (A5-23)+(S3-11), (A5-23)+(S4-1), (A5-23)+(S4-5), (A5-23)+(S4-6), (A5-23)+(S11-1), (A5-23)+(S11-2), (A5-23)+(S11-3), (A5- 23)+(S13-1), (A5-23)+(S13-2), (A5-23)+(S13-3), (A5-23)+(S13-8), (A5-23)+(S14-1), (A5-23)+(S14-2), (A5-23)+(S14-3),

(A5-24)+(S1-1), (A5-24)+(S1-7), (A5-24)+(S1-11), (A5-24)+(S2-1), (A5-24)+(S3-1), (A5- 24)+(S3-2), (A5-24)+(S3-4), (A5-24)+(S3-7), (A5-24)+(S3-8), (A5-24)+(S3-10), (A5-24)+(S3-11), (A5-24)+(S4-1), (A5-24)+(S4-5), (A5-24)+(S4-6), (A5-24)+(S11-1), (A5-24)+(S11-2), (A5-24)+(S11-3), (A5- 24)+(S13-1), (A5-24)+(S13-2), (A5-24)+(S13-3), (A5-24)+(S13-8), (A5-24)+(S14-1), (A5-24)+(S14-2), (A5-24)+(S14-3),

(A5-25)+(S1-1), (A5-25)+(S1-7), (A5-25)+(S1-11), (A5-25)+(S2-1), (A5-25)+(S3-1), (A5- 25)+(S3-2), (A5-25)+(S3-4), (A5-25)+(S3-7), (A5-25)+(S3-8), (A5-25)+(S3-10), (A5-25)+(S3-11), (A5-25)+(S4-1), (A5-25)+(S4-5), (A5-25)+(S4-6), (A5-25)+(S11-1), (A5-25)+(S11-2), (A5-25)+(S11-3), (A5- 25)+(S13-1), (A5-25)+(S13-2), (A5-25)+(S13-3), (A5-25)+(S13-8), (A5-25)+(S14-1), (A5-25)+(S14-2), (A5-25)+(S14-3),

(A5-26)+(S1-1), (A5-26)+(S1-7), (A5-26)+(S1-11), (A5-26)+(S2-1), (A5-26)+(S3-1), (A5- 26)+(S3-2), (A5-26)+(S3-4), (A5-26)+(S3-7), (A5-26)+(S3-8), (A5-26)+(S3-10), (A5-26)+(S3-11), (A5-26)+(S4-1), (A5-26)+(S4-5), (A5-26)+(S4-6), (A5-26)+(S11-1), (A5-26)+(S11-2), (A5-26)+(S11-3), (A5- 26)+(S13-1), (A5-26)+(S13-2), (A5-26)+(S13-3), (A5-26)+(S13-8), (A5-26)+(S14-1), (A5-26)+(S14-2), (A5-26)+(S14-3),

(A5-27)+(S1-1), (A5-27)+(S1-7), (A5-27)+(S1-11), (A5-27)+(S2-1), (A5-27)+(S3-1), (A5- 27)+(S3-2), (A5-27)+(S3-4), (A5-27)+(S3-7), (A5-27)+(S3-8), (A5-27)+(S3-10), (A5-27)+(S3-11), (A5-27)+(S4-1), (A5-27)+(S4-5), (A5-27)+(S4-6), (A5-27)+(S11-1), (A5-27)+(S11-2), (A5-27)+(S11-3), (A5- 27)+(S13-1), (A5-27)+(S13-2), (A5-27)+(S13-3), (A5-27)+(S13-8), (A5-27)+(S14-1), (A5-27)+(S14-2), (A5-27)+(S14-3),

(A5-28)+(S1-1), (A5-28)+(S1-7), (A5-28)+(S1-11), (A5-28)+(S2-1), (A5-28)+(S3-1), (A5- 28)+(S3-2), (A5-28)+(S3-4), (A5-28)+(S3-7), (A5-28)+(S3-8), (A5-28)+(S3-10), (A5-28)+(S3-11), (A5-28)+(S4-1), (A5-28)+(S4-5), (A5-28)+(S4-6), (A5-28)+(S11-1), (A5-28)+(S11-2), (A5-28)+(S11-3), (A5- 28)+(S13-1), (A5-28)+(S13-2), (A5-28)+(S13-3), (A5-28)+(S13-8), (A5-28)+(S14-1), (A5-28)+(S14-2), (A5-28)+(S14-3),

(A5-29)+(S1-1), (A5-29)+(S1-7), (A5-29)+(S1-11), (A5-29)+(S2-1), (A5-29)+(S3-1), (A5- 29)+(S3-2), (A5-29)+(S3-4), (A5-29)+(S3-7), (A5-29)+(S3-8), (A5-29)+(S3-10), (A5-29)+(S3-11), (A5-29)+(S4-1), (A5-29)+(S4-5), (A5-29)+(S4-6), (A5-29)+(S11-1), (A5-29)+(S11-2), (A5-29)+(S11-3), (A5- 29)+(S13-1), (A5-29)+(S13-2), (A5-29)+(S13-3), (A5-29)+(S13-8), (A5-29)+(S14-1), (A5-29)+(S14-2), (A5-29)+(S14-3),

(A5-30)+(S1-1), (A5-30)+(S1-7), (A5-30)+(S1-11), (A5-30)+(S2-1), (A5-30)+(S3-1), (A5- 30)+(S3-2), (A5-30)+(S3-4), (A5-30)+(S3-7), (A5-30)+(S3-8), (A5-30)+(S3-10), (A5-30)+(S3-11), (A5-30)+(S4-1), (A5-30)+(S4-5), (A5-30)+(S4-6), (A5-30)+(S11-1), (A5-30)+(S11-2), (A5-30)+(S11-3), (A5- 30)+(S13-1), (A5-30)+(S13-2), (A5-30)+(S13-3), (A5-30)+(S13-8), (A5-30)+(S14-1), (A5-30)+(S14-2), (A5-30)+(S14-3),

(A5-31)+(S1-1), (A5-31)+(S1-7), (A5-31)+(S1-11), (A5-31)+(S2-1), (A5-31)+(S3-1), (A5- 31)+(S3-2), (A5-31)+(S3-4), (A5-31)+(S3-7), (A5-31)+(S3-8), (A5-31)+(S3-10), (A5-31)+(S3-11), (A5-31)+(S4-1), (A5-31)+(S4-5), (A5-31)+(S4-6), (A5-31)+(S11-1), (A5-31)+(S11-2), (A5-31)+(S11-3), (A5- 31)+(S13-1), (A5-31)+(S13-2), (A5-31)+(S13-3), (A5-31)+(S13-8), (A5-31)+(S14-1), (A5-31)+(S14-2), (A5-31)+(S14-3),

(A5-32)+(S1-1), (A5-32)+(S1-7), (A5-32)+(S1-11), (A5-32)+(S2-1), (A5-32)+(S3-1), (A5- 32)+(S3-2), (A5-32)+(S3-4), (A5-32)+(S3-7), (A5-32)+(S3-8), (A5-32)+(S3-10), (A5-32)+(S3-11), (A5-32)+(S4-1), (A5-32)+(S4-5), (A5-32)+(S4-6), (A5-32)+(S11-1), (A5-32)+(S11-2), (A5-32)+(S11-3), (A5- 32)+(S13-1), (A5-32)+(S13-2), (A5-32)+(S13-3), (A5-32)+(S13-8), (A5-32)+(S14-1), (A5-32)+(S14-2), (A5-32)+(S14-3),

(A5-33)+(S1-1), (A5-33)+(S1-7), (A5-33)+(S1-11), (A5-33)+(S2-1), (A5-33)+(S3-1), (A5- 33)+(S3-2), (A5-33)+(S3-4), (A5-33)+(S3-7), (A5-33)+(S3-8), (A5-33)+(S3-10), (A5-33)+(S3-11), (A5-33)+(S4-1), (A5-33)+(S4-5), (A5-33)+(S4-6), (A5-33)+(S11-1), (A5-33)+(S11-2), (A5-33)+(S11-3), (A5- 33)+(S13-1), (A5-33)+(S13-2), (A5-33)+(S13-3), (A5-33)+(S13-8), (A5-33)+(S14-1), (A5-33)+(S14-2), (A5-33)+(S14-3),

(A5-34)+(S1-1), (A5-34)+(S1-7), (A5-34)+(S1-11), (A5-34)+(S2-1), (A5-34)+(S3-1), (A5- 34)+(S3-2), (A5-34)+(S3-4), (A5-34)+(S3-7), (A5-34)+(S3-8), (A5-34)+(S3-10), (A5-34)+(S3-11), (A5-34)+(S4-1), (A5-34)+(S4-5), (A5-34)+(S4-6), (A5-34)+(S11-1), (A5-34)+(S11-2), (A5-34)+(S11-3), (A5- 34)+(S13-1), (A5-34)+(S13-2), (A5-34)+(S13-3), (A5-34)+(S13-8), (A5-34)+(S14-1), (A5-34)+(S14-2), (A5-34)+(S14-3),

(A5-35)+(S1-1), (A5-35)+(S1-7), (A5-35)+(S1-11), (A5-35)+(S2-1), (A5-35)+(S3-1), (A5- 35)+(S3-2), (A5-35)+(S3-4), (A5-35)+(S3-7), (A5-35)+(S3-8), (A5-35)+(S3-10), (A5-35)+(S3-11), (A5-35)+(S4-1), (A5-35)+(S4-5), (A5-35)+(S4-6), (A5-35)+(S11-1), (A5-35)+(S11-2), (A5-35)+(S11-3), (A5- 35)+(S13-1), (A5-35)+(S13-2), (A5-35)+(S13-3), (A5-35)+(S13-8), (A5-35)+(S14-1), (A5-35)+(S14-2), (A5-35)+(S14-3),

(A5-36)+(S1-1), (A5-36)+(S1-7), (A5-36)+(S1-11), (A5-36)+(S2-1), (A5-36)+(S3-1), (A5- 36)+(S3-2), (A5-36)+(S3-4), (A5-36)+(S3-7), (A5-36)+(S3-8), (A5-36)+(S3-10), (A5-36)+(S3-11), (A5-36)+(S4-1), (A5-36)+(S4-5), (A5-36)+(S4-6), (A5-36)+(S11-1), (A5-36)+(S11-2), (A5-36)+(S11-3), (A5- 36)+(S13-1), (A5-36)+(S13-2), (A5-36)+(S13-3), (A5-36)+(S13-8), (A5-36)+(S14-1), (A5-36)+(S14-2), (A5-36)+(S14-3),

(A5-37)+(S1-1), (A5-37)+(S1-7), (A5-37)+(S1-11), (A5-37)+(S2-1), (A5-37)+(S3-1), (A5- 37)+(S3-2), (A5-37)+(S3-4), (A5-37)+(S3-7), (A5-37)+(S3-8), (A5-37)+(S3-10), (A5-37)+(S3-11), (A5-37)+(S4-1), (A5-37)+(S4-5), (A5-37)+(S4-6), (A5-37)+(S11-1), (A5-37)+(S11-2), (A5-37)+(S11-3), (A5- 37)+(S13-1), (A5-37)+(S13-2), (A5-37)+(S13-3), (A5-37)+(S13-8), (A5-37)+(S14-1), (A5-37)+(S14-2), (A5-37)+(S14-3),

(A5-38)+(S1-1), (A5-38)+(S1-7), (A5-38)+(S1-11), (A5-38)+(S2-1), (A5-38)+(S3-1), (A5- 38)+(S3-2), (A5-38)+(S3-4), (A5-38)+(S3-7), (A5-38)+(S3-8), (A5-38)+(S3-10), (A5-38)+(S3-11), (A5-38)+(S4-1), (A5-38)+(S4-5), (A5-38)+(S4-6), (A5-38)+(S11-1), (A5-38)+(S11-2), (A5-38)+(S11-3), (A5- 38)+(S13-1), (A5-38)+(S13-2), (A5-38)+(S13-3), (A5-38)+(S13-8), (A5-38)+(S14-1), (A5-38)+(S14-2), (A5-38)+(S14-3),

(A5-39)+(S1-1), (A5-39)+(S1-7), (A5-39)+(S1-11), (A5-39)+(S2-1), (A5-39)+(S3-1), (A5- 39)+(S3-2), (A5-39)+(S3-4), (A5-39)+(S3-7), (A5-39)+(S3-8), (A5-39)+(S3-10), (A5-39)+(S3-11), (A5-39)+(S4-1), (A5-39)+(S4-5), (A5-39)+(S4-6), (A5-39)+(S11-1), (A5-39)+(S11-2), (A5-39)+(S11-3), (A5- 39)+(S13-1), (A5-39)+(S13-2), (A5-39)+(S13-3), (A5-39)+(S13-8), (A5-39)+(S14-1), (A5-39)+(S14-2), (A5-39)+(S14-3),

(A5-40)+(S1-1), (A5-40)+(S1-7), (A5-40)+(S1-11), (A5-40)+(S2-1), (A5-40)+(S3-1), (A5- 40)+(S3-2), (A5-40)+(S3-4), (A5-40)+(S3-7), (A5-40)+(S3-8), (A5-40)+(S3-10), (A5-40)+(S3-11), (A5-40)+(S4-1), (A5-40)+(S4-5), (A5-40)+(S4-6), (A5-40)+(S11-1), (A5-40)+(S11-2), (A5-40)+(S11-3), (A5- 40)+(S13-1), (A5-40)+(S13-2), (A5-40)+(S13-3), (A5-40)+(S13-8), (A5-40)+(S14-1), (A5-40)+(S14-2), (A5-40)+(S14-3),

(A5-41)+(S1-1), (A5-41)+(S1-7), (A5-41)+(S1-11), (A5-41)+(S2-1), (A5-41)+(S3-1), (A5- 41)+(S3-2), (A5-41)+(S3-4), (A5-41)+(S3-7), (A5-41)+(S3-8), (A5-41)+(S3-10), (A5-41)+(S3-11), (A5-41)+(S4-1), (A5-41)+(S4-5), (A5-41)+(S4-6), (A5-41)+(S11-1), (A5-41)+(S11-2), (A5-41)+(S11-3), (A5- 41)+(S13-1), (A5-41)+(S13-2), (A5-41)+(S13-3), (A5-41)+(S13-8), (A5-41)+(S14-1), (A5-41)+(S14-2), (A5-41)+(S14-3),

(A5-42)+(S1-1), (A5-42)+(S1-7), (A5-42)+(S1-11), (A5-42)+(S2-1), (A5-42)+(S3-1), (A5- 42)+(S3-2), (A5-42)+(S3-4), (A5-42)+(S3-7), (A5-42)+(S3-8), (A5-42)+(S3-10), (A5-42)+(S3-11), (A5-42)+(S4-1), (A5-42)+(S4-5), (A5-42)+(S4-6), (A5-42)+(S11-1), (A5-42)+(S11-2), (A5-42)+(S11-3), (A5- 42)+(S13-1), (A5-42)+(S13-2), (A5-42)+(S13-3), (A5-42)+(S13-8), (A5-42)+(S14-1), (A5-42)+(S14-2), (A5-42)+(S14-3),

(A5-43)+(S1-1), (A5-43)+(S1-7), (A5-43)+(S1-11), (A5-43)+(S2-1), (A5-43)+(S3-1), (A5- 43)+(S3-2), (A5-43)+(S3-4), (A5-43)+(S3-7), (A5-43)+(S3-8), (A5-43)+(S3-10), (A5-43)+(S3-11), (A5-43)+(S4-1), (A5-43)+(S4-5), (A5-43)+(S4-6), (A5-43)+(S11-1), (A5-43)+(S11-2), (A5-43)+(S11-3), (A5- 43)+(S13-1), (A5-43)+(S13-2), (A5-43)+(S13-3), (A5-43)+(S13-8), (A5-43)+(S14-1), (A5-43)+(S14-2), (A5-43)+(S14-3),

(A5-44)+(S1-1), (A5-44)+(S1-7), (A5-44)+(S1-11), (A5-44)+(S2-1), (A5-44)+(S3-1), (A5- 44)+(S3-2), (A5-44)+(S3-4), (A5-44)+(S3-7), (A5-44)+(S3-8), (A5-44)+(S3-10), (A5-44)+(S3-11), (A5-44)+(S4-1), (A5-44)+(S4-5), (A5-44)+(S4-6), (A5-44)+(S11-1), (A5-44)+(S11-2), (A5-44)+(S11-3), (A5- 44)+(S13-1), (A5-44)+(S13-2), (A5-44)+(S13-3), (A5-44)+(S13-8), (A5-44)+(S14-1), (A5-44)+(S14-2), (A5-44)+(S14-3),

(A5-45)+(S1-1), (A5-45)+(S1-7), (A5-45)+(S1-11), (A5-45)+(S2-1), (A5-45)+(S3-1), (A5- 45)+(S3-2), (A5-45)+(S3-4), (A5-45)+(S3-7), (A5-45)+(S3-8), (A5-45)+(S3-10), (A5-45)+(S3-11), (A5-45)+(S4-1), (A5-45)+(S4-5), (A5-45)+(S4-6), (A5-45)+(S11-1), (A5-45)+(S11-2), (A5-45)+(S11-3), (A5- 45)+(S13-1), (A5-45)+(S13-2), (A5-45)+(S13-3), (A5-45)+(S13-8), (A5-45)+(S14-1), (A5-45)+(S14-2), (A5-45)+(S14-3),

(A5-46)+(S1-1), (A5-46)+(S1-7), (A5-46)+(S1-11), (A5-46)+(S2-1), (A5-46)+(S3-1), (A5- 46)+(S3-2), (A5-46)+(S3-4), (A5-46)+(S3-7), (A5-46)+(S3-8), (A5-46)+(S3-10), (A5-46)+(S3-11), (A5-46)+(S4-1), (A5-46)+(S4-5), (A5-46)+(S4-6), (A5-46)+(S11-1), (A5-46)+(S11-2), (A5-46)+(S11-3), (A5- 46)+(S13-1), (A5-46)+(S13-2), (A5-46)+(S13-3), (A5-46)+(S13-8), (A5-46)+(S14-1), (A5-46)+(S14-2), (A5-46)+(S14-3).

In the context of the present invention, preference is given to herbicide safener compositions of the herbicides (A) with the following safeners: mefenpyr-diethyl, fenchlorazole, isoxadifen-ethyl, cloquintocet-mexyl, dichlormid, 3-dichloroacetyl-2,2,5-trimethyl-1,3-oxazolidine, benoxacor, 3-dichloroacetyl-1-oxa-3-azaspiro[4,5]decane, 1-dichloroacetylazepane, furilazole, ((R)-3-dichloroacetyl-5-(2-furyl)-2,2-dimethyloxazolidine), cyprosulfamide, N-isopropyl-4-sulfamoylbenzamide-1-(2-methoxyphenyl)ethanone, 1-[4-(N-2-methoxybenzoylsulfamoyl)phenyl]-3-methylurea, oxabetrinil, fluxofenim, cyometrinil, 1,8-naphthalenedicarboxylic anhydride, fenclorim, flurazole, dietholate, dimepiperate, daimuron and cumyluron.

Particular preference is given to compositions of the herbicides (A) with the safeners: daimuron, benoxacor, furilazole, fluxofenim, fenchlorazole (ethyl ester), mefenpyr-diethyl, cloquintocet-mexyl, isoxadifen-ethyl, cyprosulfamide, flurazole, oxabetrinil, dichlormid and dietholate.

Very particular preference is given to herbicide safener compositions of the herbicides (A) with the following safeners: mefenpyr-diethyl, isoxadifen-ethyl, cyprosulfamide, fenchlorazole ethyl ester, benoxacor, cloquintocet-mexyl, fluxofenim and furilazole.

Particularly, very particular preference is given to herbicide safener compositions of herbicides (A) of the formula (I),

in which

Q represents Q⁵,

R¹ represents 2-methylphenyl, 2-methoxyphenyl or 2-trifluoromethylphenyl,

R² represents methyl,

X represents methyl,

W represents hydrogen,

Y represents CR^{s6}R^{s7},

R^{s1} represents hydroxy,

R^{s2} represents hydrogen,

R^{s3} represents hydrogen,

R^{s4} represents hydrogen,

R^{s5} represents hydrogen,

R^{s6} represents hydrogen or methyl,

R^{s7} represents hydrogen or methyl,

and the safeners mefenpyr-diethyl, fenchlorazole (ethyl ester), isoxadifen-ethyl, cloquintocet-mexyl, benoxacor, furilazole, cyprosulfamide, fluxofenim and 1-[4-(N-2-methoxybenzoylsulfamoyl)phenyl]-3-methylurea.

“Herbicidally active amount” in the sense of the invention is an amount of one or more herbicides suitable for having an adverse impact on plant growth. “Antidotically active amount” in the sense of the invention means an amount of one or more safeners suitable for reducing the phytotoxic effect of active compounds of crop protection compositions (for example of herbicides) on crop plants.

The safeners (B) are suitable for reduction of phytotoxic effects which can occur when herbicides of the general formula (I) are used in crops of useful plants, without significantly impairing the efficacy of these active herbicidal compounds against harmful plants. As a result of this, it is possible to extend the field of use of conventional crop protection compositions quite considerably, for example to crops in which use of the herbicides has been possible to date only to a limited degree, if at all.

According to the indication and active herbicidal compound used, the application rates of the safeners required may vary within wide limits and are generally in the range from 0.001 to 5 kg, preferably 0.005 to 2.5 kg and particularly 0.05 to 0.5 kg of active compound per hectare.

The herbicides (A) and the safeners (B) can be deployed together (for example as a ready-made formulation or by the tank-mix method) or successively in any sequence, for example by application by spraying, watering and sprinkling, or by granule scattering. The weight ratio of herbicide of the general formula (I) (A):safener (B) may vary within wide limits and is preferably in the range from 1:10 000 to 10 000:1, especially from 1:1000 to 1000:1 and very particularly from 1:20 to 20:1. The amounts of the general formula (I) (A) and safener (B) which are optimal in each case depend on the type of herbicide used and the safener used and on the nature and development stage of the plant stock to be treated, and can be determined in each individual case by simple, routine preliminary tests.

According to their properties, the safeners (B) present in the herbicide safener compositions according to the invention can each be used for pretreatment of the seed of the crop plant (for example for dressing of the seed) or introduced into the seed furrows prior to sowing or employed together with the herbicide prior to or after emergence of the plants. Pre-emergence treatment includes both the treatment of the area under cultivation (including any water present in the area under cultivation, for example in the case of applications to rice) prior to sowing and the treatment of the areas under cultivation in which seeds have been sown but which are not yet covered by growing plants. Preference is given to application together with the herbicide. For this purpose, it is possible to use tank-mixes or ready-made formulations.

In a preferred embodiment, the seed (for example grains, seeds or vegetative propagation organs such as tubers or budded parts of shoots) or seedlings are pretreated with the safeners (B), optionally in combination with other active agrochemical compounds. For pretreatment of the seed, the active compounds can be applied to the seed, for example by dressing, or the active compounds and the seed can be added to water or other solvents, and the active compounds can be taken up, for example, by adsorption or diffusion in a dipping process or by swelling or pre-germination. For pretreatment of seedlings, the young plants can be contacted with the safeners, optionally in combination with other active agrochemical ingredients, for example by spraying, dipping or watering, and then transplanted and optionally aftertreated with the herbicides (A).

The seed or seedlings can be treated with the safeners (B) alone or together with other active agrochemical ingredients—such as fungicides, insecticides or plant fortifiers, fertilizers or swelling and germination accelerators. After the pretreatment application, the safeners may subsequently be applied once again before, after or together with one or more herbicides (A), possibly also in combination with other known herbicides. The pretreatment of the seed or seedlings can achieve improved long-term efficacy of the safeners.

Thus, the present invention furthermore provides a method for controlling unwanted plants in crop plants, which comprises applying the herbicides (A) and the safeners (B) of the herbicide safener compositions according to the invention to the plants (for example harmful plants, such as monocotyledonous or dicotyledonous weeds or unwanted crop plants), the seed (for example grains, seeds or vegetative propagation organs, such as tubers or budded parts of shoots) or the area on which the plants grow (for example the area under cultivation), for example together or separately. It is possible here to apply one or more safeners (B), preferably one or more compounds, especially one compound, from groups (S1) to (S15) before, after or simultaneously with the herbicide(s) of the general formula (I) (A) to the plants, the seed or the area on which the plants grow (for example the area under cultivation). In a preferred embodiment, the safeners (B) are used for seed treatment.

Unwanted plants are understood to mean all plants which grow at sites where they are unwanted. These may, for example, be harmful plants (for example monocotyledonous or dicotyledonous weeds or unwanted crop plants), including, for example, those which are resistant to certain active herbicidal compounds, such as glyphosate, atrazine, glufosinate or imidazolinone herbicides.

Monocotyledonous weeds originate from, for example, the genera Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristylis, Sagittaria, Eleocharis, Scirpus, Pasp alum, Ischaemum, Sphenoclea, Dactyloctenium, Agrostis, Alopecurus, Apera. Dicotyledonous weeds originate from, for example, the genera Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum, Euphorbia.

Preferably, in the method of the invention, an effective amount of the herbicides (A) and the safeners (B) for control of harmful plants is applied in plant crops, for example in economically important farm crops, e.g. monocotyledonous farm crops such as cereals (e.g. wheat, barley, rye, oats), rice, corn, millet/sorghum, or dicotyledonous farm crops such as sugar beet, oilseed rape, cotton, sunflower and legumes, for example of the genera Glycine (e.g. Glycine max. such as non-transgenic Glycine max. (e.g. conventional varieties such as STS varieties) or transgenic Glycine max. (e.g. RR soya or LL soya) and crosses thereof), Phaseolus, Pisum, Vicia and Arachis, or vegetable crops from various botanic groups, such as potato, leek, cabbage, carrot, tomato, onion, and permanent crops and plantation crops such as pome fruit and stone fruit, berries, grapes, hevea, bananas, sugar cane, coffee, tea, citrus, nut plantations, lawns, palm crops and forestry crops.

The invention also provides for the use of the herbicide safener compositions according to the invention for controlling unwanted vegetation, preferably in plant crops.

The herbicide safener compositions according to the invention can be prepared by known processes, for example as mixed formulations of the individual components, if appropriate with further active compounds, additives and/or customary formulation auxiliaries, which combinations are then applied in a customary manner diluted with water, or are prepared as so-called tank-mixes by joint dilution of the individual components, formulated separately or formulated partially separately, with water. Likewise possible is the application at different times (split application) of the separately formulated or partly separately formulated individual components. It is also possible to apply the individual components or the herbicide safener compositions in several portions (sequential application), for example pre-emergence applications followed by post-emergence applications, or early post-emergence applications followed by post-emergence applications at an intermediate or late stage. Preference is given to the joint or immediately successive application of the active compounds of the composition in question.

The herbicide safener compositions according to the invention can also be used for control of harmful plants in crops of genetically modified plants which are known or are yet to be developed.

In general, the transgenic plants are characterized by particular advantageous properties, for example by resistances to certain pesticides, in particular certain herbicides, resistances to plant diseases or pathogens of plant diseases, such as certain insects or microorganisms such as fungi, bacteria or viruses. Other particular properties relate, for example, to the harvested material with regard to quantity, quality, storability, composition and specific constituents. For instance, there are known transgenic plants with an elevated starch content or altered starch quality, or those with a different fatty acid composition in the harvested material. Other particular properties may be tolerance or resistance to abiotic stressors, for example heat, low temperatures, drought, salinity and ultraviolet radiation.

Preference is given to the use of the herbicide safener compositions according to the invention in economically important transgenic crops of useful plants and ornamentals, for example of cereals such as wheat, barley, rye, oats, millet/sorghum, rice, cassava and corn, or else crops of sugar beet, cotton, soybean, oilseed rape, potato, tomato, peas and other vegetables. The herbicides (A) can preferably be used in crops of useful plants which are resistant, or have been made resistant by recombinant means, to the phytotoxic effects of the herbicides.

Conventional ways of producing novel plants which have modified properties in comparison to existing plants consist, for example, in traditional cultivation methods and the generation of mutants. Alternatively, novel plants with modified properties can be generated with the aid of recombinant methods (see, for example, EP-A-0221044, EP-A-0131624). For example, there have been descriptions in several cases of:
genetic modifications of crop plants for the purpose of modifying the starch synthesized in the plants (for example WO 92/11376, WO 92/14827, WO 91/19806),
transgenic crop plants which are resistant to particular herbicides of the glufosinate type (cf., for example, EP-A-0242236, EP-A-242246) or glyphosate type (WO 92/00377) or of the sulfonylurea type (EP-A-0257993, U.S. Pat. No. 5,013,659),
transgenic crop plants, for example cotton, with the ability to produce Bacillus thuringiensis toxins (Bt toxins), which make the plants resistant to particular pests (EP-A-0142924, EP-A-0193259),
transgenic crop plants having a modified fatty acid composition (WO 91/13972),
genetically modified crop plants with novel constituents or secondary metabolites, for example novel phytoalexins, which bring about an increased disease resistance (EPA 309862, EPA0464461),
genetically modified plants having reduced photorespiration, which have higher yields and higher stress tolerance (EPA 0305398),
transgenic crop plants which produce pharmaceutically or diagnostically important proteins (“molecular pharming”),
transgenic crop plants which feature higher yields or better quality,
transgenic crop plants which feature a combination, for example, of the abovementioned novel properties (“gene stacking”).

Numerous molecular biology techniques which can be used to produce novel transgenic plants with modified properties are known in principle; see, for example, I. Potrykus and G. Spangenberg (eds.) Gene Transfer to Plants, Springer Lab Manual (1995), Springer Verlag Berlin, Heidelberg, or Christou, “Trends in Plant Science” 1 (1996) 423-431.

For such genetic manipulations, nucleic acid molecules which allow mutagenesis or sequence alteration by recombination of DNA sequences can be introduced into plasmids. With the aid of standard methods, it is possible, for example, to undertake base exchanges, remove parts of sequences or add natural or synthetic sequences. To join the DNA fragments with one another, adapters or linkers can be placed onto the fragments, see, for example, Sambrook et al., 1989, Molecular Cloning, A Laboratory Manual, 2nd ed. Cold Spring Harbor Laboratory Press, Cold Spring Harbor, N.Y.; or Winnacker “Gene and Klone” [Genes and Clones], VCH Weinheim 2nd edition 1996.

For example, the generation of plant cells with a reduced activity of a gene product can be achieved by expressing at least one corresponding antisense RNA, a sense RNA for achieving a cosuppression effect, or by expressing at least one suitably constructed ribozyme which specifically cleaves transcripts of the abovementioned gene product.

To this end, it is firstly possible to use DNA molecules which encompass the entire coding sequence of a gene product inclusive of any flanking sequences which may be present, and also DNA molecules which only encompass portions of the coding sequence, in which case it is necessary for these portions to be long enough to have an antisense effect in the cells. It is also possible to use DNA sequences which have a high degree of homology to the coding sequences of a gene product, but are not completely identical to them.

When expressing nucleic acid molecules in plants, the protein synthesized may be localized in any desired compartment of the plant cell. However, to achieve localization in a particular compartment, it is possible, for example, to join the coding region to DNA sequences which ensure localization in a particular compartment. Such sequences are known to those skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106). The nucleic acid molecules can also be expressed in the organelles of the plant cells.

The transgenic plant cells can be regenerated by known techniques to give rise to entire plants. In principle, the transgenic plants may be plants of any desired plant species, i.e. not only monocotyledonous but also dicotyledonous plants.

Thus, transgenic plants can be obtained whose properties are altered by overexpression, suppression or inhibition of homologous (=natural) genes or gene sequences or expression of heterologous (=foreign) genes or gene sequences.

Preferably, the herbicide safener compositions according to the invention can be used in transgenic crops which are resistant to growth regulators, for example dicamba, or to herbicides which inhibit essential plant enzymes, for example acetolactate synthases (ALS), EPSP synthases, glutamine synthases (GS) or hydroxyphenylpyruvate dioxygenases (HPPD), or to herbicides from the group of the sulfonylureas, the glyphosates, glufosinates or benzoylisoxazoles and analogous active compounds.

When the herbicide safener compositions according to the invention according to the invention are employed in transgenic crops, not only do the effects toward harmful plants observed in other crops occur, but frequently also effects which are specific to application in the particular transgenic crop, for example an altered or specifically widened spectrum of weeds which can be controlled, altered application rates which can be used for the application, preferably good combinability with the herbicides to which the transgenic crop is resistant, and influencing of growth and yield of the transgenic crop plants.

The invention therefore also provides for the use of the herbicide safener compositions according to the invention according to the invention for control of harmful plants in transgenic crop plants.

Preference is given to the use of the herbicide safener compositions according to the invention in economically important transgenic crops of useful plants and ornamentals, for example of cereals (e.g. wheat, barley, rye, oats), millet/sorghum, rice, cassava and corn, or else crops of sugar beet, cotton, soybean, oilseed rape, potato, tomato, peas and other vegetable crops.

The invention therefore also provides for the use of the herbicide safener compositions according to the invention for control of harmful plants in transgenic crop plants or crop plants having tolerance through selective breeding.

The herbicides (A) and the safeners (B) can be converted together or separately to customary formulations, for example for application by spraying, watering, sprinkling and seed dressing, such as solutions, emulsions, suspensions, powders, foams, pastes, granules, aerosols, active compound-impregnated natural and synthetic substances, microencapsulations in polymeric substances. The formulations may comprise the customary auxiliaries and additives.

These formulations are produced in a known manner, for example by mixing the active compounds with extenders, that is, liquid solvents, liquefied gases under pressure, and/or solid carriers, optionally with the use of surfactants, that is emulsifiers and/or dispersants, and/or foam formers.

When the extender used is water, it is also possible to use, for example, organic solvents as auxiliary solvents. Suitable liquid solvents are essentially: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and the ethers and esters thereof, ketones such as acetone, methyl ethyl ketone, methyl isobutyl ketone or cyclohexanone, strongly polar solvents such as dimethylformamide or dimethyl sulfoxide, and water.

Useful solid carriers include: for example ammonium salts and ground natural minerals, such as kaolins, clays, talc, chalk, quartz, attapulgite, montmorillonite or diatomaceous earth, and ground synthetic minerals, such as finely divided silica, alumina and silicates; useful solid carriers for granules include: for example crushed and fractionated natural rocks, such as calcite, marble, pumice, sepiolite, dolomite and synthetic granules of inorganic and organic flours, and granules of organic material, such as sawdust, coconut shells, corn cobs and tobacco stalks; useful emulsifiers and/or foam formers include: for example nonionic and anionic emulsifiers, such as polyoxyethylene fatty acid esters, polyoxyethylene fatty alcohol ethers, e.g. alkylaryl polyglycol ethers, alkylsulfonates, alkylsulfates, arylsulfonates and protein hydrolyzates; useful dispersants include: for example lignosulfite waste liquors and methylcellulose.

Tackifiers, such as carboxymethyl cellulose, natural and synthetic polymers in the form of powders, granules or latices, such as gum arabic, polyvinyl alcohol and polyvinyl acetate, and also natural phospholipids, such as cephalins and lecithins, and synthetic phospholipids can be used in the formulations. Further additives may be mineral and vegetable oils.

It is possible to use colorants such as inorganic pigments, for example iron oxide, titanium oxide and Prussian blue, and organic colorants such as alizarin colorants, azocolorants and metal phthalocyanine colorants, and trace nutrients such as salts of iron, manganese, boron, copper, cobalt, molybdenum and zinc.

The formulations generally comprise between 0.1 and 95 percent by weight of active compound, preferably between 0.5 and 90% by weight.

The herbicides (A) and the safeners (B) can also be used as such or in formulations thereof in a mixture with other active agrochemical ingredients, such as known herbicides, for controlling unwanted vegetation, for example for controlling weeds or for controlling unwanted crop plants, possible examples being ready-made formulations or tank-mixes.

Also possible are mixtures with other known active compounds such as fungicides, insecticides, acaricides, nematicides, bird antifeedants, plant nutrients and soil improvers, and likewise with additives and formulation auxiliaries customary in crop protection.

The herbicides (A) and the safeners (B) can be used as such, in the form of formulations thereof or in the use forms prepared therefrom by further dilution, such as ready-to-use solutions, suspensions, emulsions, powders, pastes and granules. Application is typically accomplished, for example, by watering, sprinkling, spraying, broadcasting.

The active compounds can be deployed on the plants, plant parts, seed or area under cultivation (farmland), preferably on the seed or the green plants and plant parts, and optionally additionally to the farmland. One possible use is the joint application of the active compounds in the form of tank-mixes, where the optimally formulated concentrated formulations of the individual active compounds are, together, mixed in a tank with water, and the spray liquor obtained is applied.

A co-formulation of the herbicide safener compositions according to the invention of herbicide (A) and safener (B) has the advantage of easier applicability, since the amounts of the components can already be set in an optimum ratio. Moreover, the auxiliaries in the formulation can be optimized to one another.

Combination partners usable for the herbicide safener compositions according to the invention in mixed formulations or in a tank-mix are, for example, known, preferably herbicidal, active compounds based on inhibition of, for example, acetolactate synthase, acetyl coenzyme A carboxylase, PS I, PS II, HPPD, phytoene desaturase, protoporphyrinogen oxidase, glutamine synthetase, cellulose biosynthesis, 5-enolpyruvylshikimate-3-phosphate synthetase. Such compounds and also other usable compounds, some with an unknown or different mechanism of action, are described, for example, in Weed Research 26, 441-445 (1986), or in the handbook “The Pesticide Manual”, 12th edition 2000, or 13th edition 2003 or 14th edition 2006/2007, or in the corresponding “e-Pesticide Manual”, Version 5.0 (October 2008), each published by the British Crop Protection Council, (also referred to hereinafter as “PM”), and literature cited therein. Lists of common names are also available in “The Compendium of Pesticide Common Names” on the Internet. Herbicides known from the literature which can be combined with the herbicide safener compositions according to the invention are, for example, the following active compounds (note: The compounds are referred to either by the “common name” in accordance with the International Organization for Standardization (ISO) or by the chemical name, if appropriate together with a customary code number, and in each case include all use forms, such as acids, salts, esters and isomers, such as stereoisomers and optical isomers. In this case, one or else, in some cases, more than one application form is mentioned.):

2,4-D, acetochlor, acifluorfen, acifluorfen-sodium, aclonifen, alachlor, alloxydim, alloxydim-sodium, ametryn, amicarbazone, amidosulfuron, aminopyralid, amitrole, anilofos, asulam, atrazine, azafenidin, azimsulfuron, beflubutamid, benazolin, benazolin-ethyl, benfuresate, bensulfuron-methyl, bentazone, benzfendizone, benzobicyclon, benzofenap, bifenox, bilanafos, bispyribac-sodium, bromacil, bromobutide, bromofenoxim, bromoxynil, butachlor, butafenacil, butenachlor, butralin, butroxydim, butylate, cafenstrole, carbetamide, carfentrazone-ethyl, chlomethoxyfen, chloridazon, chlorimuron-ethyl, chlornitrofen, chlortoluron, chlorsulfuron, cinidon-ethyl, cinmethylin, cinosulfuron, clefoxydim, clethodim, clodinafop-propargyl, clomazone, clomeprop, clopyralid, cloransulam-methyl, cumyluron, cyanazine, cyclosulfamuron, cycloxydim, cyhalofop-butyl, desmedipham, dicamba, dichlobenil, dichlorprop, dichlorprop-P, diclofop-methyl, diclosulam, difenzoquat, diflufenican, diflufenzopyr, dikegulac-sodium, dimefuron, dimepiperate, dimethachlor, dimethametryn, dimethenamid, triaziflam, diquat dibromide, dithiopyr, diuron, dymron, EPTC, esprocarb, ethalfluralin, ethametsulfuron-methyl, ethofumesate, ethoxyfen, ethoxysulfuron, etobenzanid, fenoxaprop-ethyl, fenoxaprop-P-ethyl, fentrazamide, flamprop-M-isopropyl, flamprop-M-methyl, flazasulfuron, florasulam, fluazifop, fluazifop-butyl, fluazifop-P-butyl, fluazolate, flucarbazone-sodium, flucetosulfuron, fluchloralin, flufenacet, flufenpyr, flumetsulam, flumiclorac-pentyl, flumioxazin, fluometuron, fluorchloridone, fuorglycofen-ethyl, flupoxam, flupyrsulfuron-methyl-sodium, fluridone, fluroxypyr, fluroxypyr-butoxypropyl, fluroxypyr-meptyl, flurprimidol, flurtamone, fluthiacet-methyl, fomesafen, foramsulfuron, glufosinate, glufosinate-P, glufosinate-ammonium, glufosinate-P-ammonium, glufosinate-P-sodium, glyphosate, halosulfuron-methyl, haloxyfop, haloxyfop-ethoxyethyl, haloxyfop-methyl, haloxyfop-P-methyl, hexazinone, imazamethabenz-methyl, imazamox, imazapic, imazapyr, imazaquin, imazethapyr, imazosulfuron, indanofan, indaziflam, iodosulfuron-methyl-sodium, ioxynil, isoproturon, isouron, isoxaben, isoxachlortole, isoxaflutole, ketospiradox, lactofen, lenacil, linuron, MCPA, mecoprop, mecoprop-P, mefenacet, mesosulfuron-methyl, mesotrione, metamifop, metamitron, metazachlor, methabenzthiazuron, methiozolin, methyldymron, metobromuron, metolachlor, metosulam, metoxuron, metribuzin, metsulfuron-methyl, molinate, monolinuron, naproanilide, napropamide, neburon, nicosulfuron, norflurazon, orbencarb, oryzalin, oxadiargyl, oxadiazon, oxasulfuron, oxaziclomefone, oxyfluorfen, paraquat, pelargonic acid, pendimethalin, pendralin, penoxsulam, pentoxazone, pethoxamid, phenmedipham, picloram, picolinafen, pinoxaden, piperophos, pretilachlor, primisulfuron-methyl, profluazol, profoxydim, prometryn, propachlor, propanil, propaquizafop, propisochlor, propoxycarbazone-sodium, propyrisulfuron, propyzamide, prosulfocarb, prosulfuron, pyraclonil, pyraflufen-ethyl, pyrazolate, pyrazosulfuron-ethyl, pyrazoxyfen, pyribenzoxim, pyributicarb, pyridafol, pyridate, pyriftalid, pyriminobac-methyl, pyrithiobac-sodium, quinclorac, quinmerac, quinoclamine, quizalofop-ethyl, quizalofop-P-ethyl, quizalofop-P-tefuryl, rimsulfuron, sethoxydim, simazine, simetryn, S-metolachlor, sulcotrione, sulfentrazone, sulfometuron-methyl, sulfosate, sulfosulfuron, tebuthiuron, tepraloxydim, terbuthylazine, terbutryn, thenylchlor, thiazopyr, thifensulfuron-methyl, thiobencarb, tiocarbazil, tralkoxydim, triallate, triasulfuron, tribenuron-methyl, triclopyr, tridiphane, trifloxysulfuron, trifluralin, triflusulfuron-methyl and tritosulfuron.

Further possible mixing partners are pyroxasulfone, pyroxsulam, orthosulfamuron, pyrimisulfan, prohexadione-calcium, bencarbazone, SYN-523, IDH-100, SYP-249, monosulfuron, ipfencarbazone (HOK-201), pyribambenz-isopropyl, tefuryltrione, bencarbazone, tembotrione, pyrasulfotole and thiencarbazone-methyl.

For application, the formulations in commercial form are, if appropriate, diluted in a customary manner, for example in the case of wettable powders, emulsifiable concentrates, dispersions and water-dispersible granules with water. Dust-type preparations, granules for soil application or granules for scattering and sprayable solutions are not normally diluted further with other inert substances prior to application.

### BIOLOGICAL EXAMPLES

Post-Emergence Safener Action

Seeds of monocotyledonous crop plants were placed in sandy loam in wood-fiber or plastic pots, covered with soil and cultivated in a greenhouse under good growth conditions. Ten to twenty days after sowing, the test plants were treated at the one- to three-leaf stage. The herbicide safener combinations according to the invention formulated as water-soluble powders or suspensions and the correspondingly formulated herbicidally active individual compounds were, at different dosages using a water application rate of 300 l/ha (converted), and with addition of customary wetting agents and adjuvants, sprayed onto the green parts of the plants. After the treatment, the pots were maintained in a greenhouse under good growth conditions for the crop plants.

9 to 11 days and 20 to 21 days after application, the damage in percent on the treated crop plants was rated by visual scoring in comparison to the respective untreated controls.

Combinations in which the herbicidally active individual compound caused at least 30% damage to the crop plant, and where this could be reduced by at least 30 percentage points by addition of 100 g/ha safener, were rated as evidence of significant safener action.

On wheat, for example, a significant safener action was observed with the following herbicide safener combinations: (A4-2)+(S1-1), (A4-2)+(S1-7), (A4-2)+(S1-11), (A4-2)+(52-1), (A4-2)+(53-4), (A4-2)+(S3-10), (A4-2)+(S4-6), (A4-2)+(S11-2), (A4-13)+(S1-1), (A4-13)+(S1-7), (A4-13)+(S1-11), (A4-13)+(S2-1), (A4-13)+(S3-4), (A4-13)+(S3-10), (A4-13)+(S4-1), (A4-13)+(54-6), (A4-13)+(S11-2).

On barley, for example, a significant safener action was observed with the following herbicide safener combinations: (A4-2)+(S2-1), (A4-2)+(S3-4), (A4-2)+(S3-10), (A4-2)+(S11-2), (A4-13)+(S11-2).

On rice, for example, a significant safener action was observed with the following herbicide safener combinations: (A4-2)+(S1-11), (A4-2)+(S3-10), (A4-2)+(S4-1), (A4-2)+(S4-6), (A4-13)+(S1-7), (A4-13)+(S1-11), (A4-13)+(S3-10), (A4-13)+(S4-6).

On corn, for example, a significant safener action was observed with the following herbicide safener combinations: (A4-2)+(S1-11), (A4-2)+(S2-1), (A4-2)+(S3-10), (A4-2)+(S4-1), (A4-2)+(S4-6), (A4-2)+(S11-2), (A4-13)+(S1-11), (A4-13)+(S2-1), (A4-13)+(S4-1), (A4-13)+(S4-6), (A4-29)+(S1-11), (A4-29)+(S2-1), (A4-29)+(S4-1), (A4-29)+(S4-6), (A4-29)+(S11-2).

Pre-Emergence Safener Action

Corn seeds were placed in sandy loam in wood-fiber pots and covered with soil. The herbicide safener combinations according to the invention formulated as water-soluble powders or suspensions and the correspondingly formulated herbicidally active individual compounds were, at different dosages using a water application rate of 300 l/ha (converted), and with addition of customary wetting agents and adjuvants, sprayed onto the surface of the covering soil. After the treatment, the pots were kept in a greenhouse under good growth conditions for the crop plants.

9 to 11 days and 20 to 21 days after application, the damage in percent on the treated crop plants was rated by visual scoring in comparison to the respective untreated controls. Combinations in which the herbicidally active individual compound caused at least 30% damage to the crop plant, and where this could be reduced by at least 30 percentage points by addition of 100 g/ha safener, were rated as evidence of significant safener action.

On corn, for example, a significant safener action was observed with the following herbicide safener combinations:

1. A herbicide safener composition comprising
(A) one or more herbicidally active compound of formula (I) and/or a salt thereof, 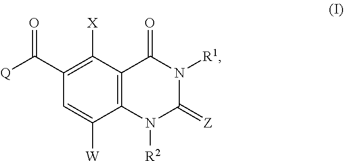
in which
X represents nitro, halogen, cyano, formyl, thiocyanato, (C₁-C₆)-alkyl, (C₁-C₆)-haloalkyl, (C₂-C₆)-alkenyl, (C₂-C₆)-haloalkenyl, (C₂-C₆)-alkynyl, (C₃-C₆)-haloalkynyl, (C₃-C₆)-cycloalkyl, (C₃-C₆)-halocycloalkyl, (C₃-C₆)-cycloalkyl-(C₁-C₆)-alkyl, (C₃-C₆)-halocycloalkyl-(C₁-C₆)-alkyl, COR¹, OR¹, OCOR¹, OSO₂R², S(O)ₙR², SO₂OR¹, SO₂N(R¹)₂, NR¹SO₂R², NR¹COR¹, (C₁-C₆)-alkyl-S(O)ₙR², (C₁-C₆)-alkyl-OR¹, (C₁-C₆)-alkyl-OCOR¹, (C₁-C₆)-alkyl-OSO₂R², (C₁-C₆)-alkyl-COOR¹, (C₁-C₆)-alkyl-SO₂OR¹, (C₁-C₆)-alkyl-CON(R¹)₂, (C₁-C₆)-alkyl-SO₂N(R¹)₂, (C₁-C₆)-alkyl-NR¹COR¹, (C₁-C₆)-alkyl-NR¹SO₂R² or NR¹R²,
Z represents O or S,
W represents hydrogen, nitro, halogen, cyano, (C₁-C₄)-alkyl, (C₁-C₄)-haloalkyl or (C₁-C₄)-alkoxy,
R¹ represents (C₁-C₁₀)-alkyl, (C₂-C₁₀)-alkenyl, (C₂-C₁₀)-alkynyl, halo-(C₁-C₁₀)-alkyl, halo-(C₂-C₁₀)-alkenyl, halo-(C₂-C₁₀)-alkynyl, (C₃-C₁₀)-cycloalkyl, halo-(C₃-C₁₀)-cycloalkyl, (C₁-C₄)-alkyl-(C₃-C₇)-cycloalkyl, (C₃-C₇)-cycloalkyl-(C₁-C₆)-alkyl, (C₃-C₇)-cycloalkyl-(C₃-C₇)-cycloalkyl, halo-(C₃-C₇)-cycloalkyl-(C₁-C₆)-alkyl, (C₁-C₆)-alkyl-(C₃-C₇)-cycloalkyl-(C₁-C₆)-alkyl, (C₃-C₁₂)-cycloalkenyl, halo-(C₃-C₁₂)-cycloalkenyl, (C₁-C₆)-alkoxy-(C₁-C₆)-alkyl, (C₁-C₆)-alkoxy-(C₂-C₆)-alkenyl, (C₁-C₆)-alkyl-(C₃-C₇)-cycloalkyl, (C₁-C₆)-alkoxy-(C₃-C₇)-cycloalkyl, di-(C₁-C₆)-alkoxy-(C₃-C₇)-cycloalkyl, (C₃-C₇)-cycloalkoxy-(C₁-C₆)-alkyl, (C₃-C₇)-cycloalkoxy-(C₁-C₆)-alkoxy-(C₁-C₆)-alkyl, (C₁-C₆)-alkoxy-(C₁-C₆)-alkoxy-(C₁-C₆)-alkyl, (C₁-C₆)-alkylthio-(C₁-C₆)-alkyl, (C₁-C₆)-alkylsulfinyl-(C₁-C₆)-alkyl, (C₁-C₆)-alkylsulfonyl-(C₁-C₆)-alkyl, (C₁-C₆)-alkylamino-(C₁-C₆)-alkyl, di-(C₁-C₆)-alkylamino-(C₁-C₆)-alkyl, halo-(C₁-C₆)-alkylamino-(C₁-C₆)-alkyl, (C₃-C₇)-cycloalkylamino-(C₁-C₆)-alkyl, (C₁-C₆)-alkyl-carbonyl, halo-(C₁-C₆)-alkyl-carbonyl, (C₃-C₇)-cycloalkyl-carbonyl, (C₁-C₆)-alkoxy-carbonyl, (C₃-C₇)-cycloalkoxy-carbonyl, (C₃-C₇)-cycloalkyl-(C₁-C₆)-alkoxy-carbonyl, (C₁-C₆)-alkylamino-carbonyl, di-(C₁-C₆)-alkylamino-carbonyl, (C₃-C₇)-cycloalkylamino-carbonyl, cyano-(C₁-C₆)-alkyl, hydroxy-(C₁-C₆)-alkyl, (C₃-C₇)-cycloalkenyl-(C₁-C₆)-alkyl, halo-(C₁-C₆)-alkoxy-(C₁-C₆)-alkyl, (C₁-C₆)-alkoxy-halo-(C₁-C₆)-alkyl, halo-(C₁-C₆)-alkoxy-halo-(C₁-C₆)-alkyl, halo-(C₃-C₇)-cycloalkoxy-(C₁-C₆)-alkyl, (C₃-C₇)-cycloalkenyloxy-(C₁-C₆)-alkyl, halo-(C₃-C₇)-cycloalkenyloxy-(C₁-C₆)-alkyl, di-(C₁-C₆)-alkoxy-(C₁-C₆)-alkyl, (C₁-C₆)-alkoxy-(C₁-C₆)-alkyl-carbonyl, (C₁-C₆)-alkoxy-carbonyl-(C₁-C₆)-alkyl, halo-(C₁-C₆)-alkoxy-carbonyl, (C₁-C₁₀)-alkoxy, halo-(C₁-C₁₀)-alkoxy, (C₃-C₁₂)-cycloalkoxy, halo-(C₃-C₇)-cycloalkoxy, (C₃-C₇)-cycloalkyl-(C₁-C₆)-alkoxy, (C₂-C₁₂)-alkenyloxy, halo-(C₂-C₁₀)-alkenyloxy, (C₂-C₁₀)-alkynyloxy, halo-(C₃-C₁₀)-alkynyloxy, (C₁-C₆)-alkoxy-(C₁-C₆)-alkoxy, (C₁-C₆)-alkyl-carbonyloxy, halo-(C₂-C₁₂)-alkyl-carbonyloxy, (C₃-C₇)-cycloalkyl-carbonyloxy, (C₁-C₆)-alkyl-carbonyl-(C₁-C₆)-alkoxy, (C₁-C₆)-alkylamino, di-(C₁-C₆)-alkylamino, halo-(C₁-C₆)-alkylamino, halo-di-(C₁-C₆)-alkylamino, (C₃-C₁₂)-cycloalkylamino, (C₁-C₆)-alkyl-carbonylamino, halo-(C₁-C₆)-alkyl-carbonylamino, (C₁-C₁₀)-alkylsulfonylamino, halo-(C₁-C₁₀)-alkylsulfonylamino, (C₃-C₇)-cycloalkyl-(C₁-C₆)-alkyl-amino, hydroxy, amino, NHCHO, or
R¹ represents phenyl, phenylsulfonyl, W¹-(phenyl), W¹—(O-phenyl), W¹—(S-phenyl), W¹—(SO₂-phenyl), W²—(SO₂CH₂-phenyl) or W²—(SCH₂-phenyl), where the phenyl rings of the eight above-mentioned radicals each carry s substituents R⁶,
R² represents hydrogen, (C₁-C₄)-alkyl, (C₁-C₄)-haloalkyl, (C₂-C₆)-alkenyl, (C₂-C₆)-haloalkenyl, (C₂-C₆)-alkynyl, (C₂-C₆)-haloalkynyl, (C₃-C₆)-cycloalkyl, (C₃-C₆)-halocycloalkyl, (C₁-C₆)-alkyl-O-(C₁-C₆)-alkyl, (C₃-C₆)-cycloalkyl-(C₁-C₆)-alkyl, phenyl, phenyl-(C₁-C₆)-alkyl, pyridyl or (C₁-C₆)-alkylpyridyl, where the phenyl or pyridyl rings of the four abovementioned radicals each carry s substituents R⁶,
Q represents a radical Q⁵, Q⁶, Q⁷ or Q⁸, 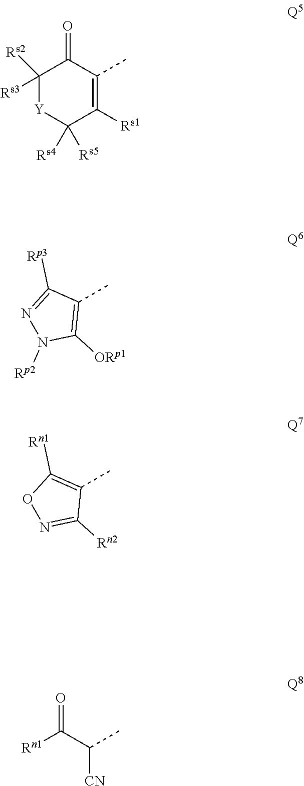
Y represents O, CO or CR^{s6}R^{s7},
R^{s1} represents hydroxy or SR⁷,
R^{s2} and R^{s5} independently of one another each represent hydrogen or (C₁-C₄)-alkyl, or
R^{s2} and R^{s5} together form an ethylene or vinylene group,
R^{s3}, R^{s4}, R^{s6} and R^{s7} independently of one another each represent hydrogen or (C₁-C₄)-alkyl,
R^{p1} represents hydrogen, (C₁-C₆)-alkylsulfonyl, (C₁-C₄)-alkoxy-(C₁-C₆)-alkylsulfonyl, or represents phenylsulfonyl, thiophenyl-2-sulfonyl, benzoyl, benzoyl-(C₁-C₆)-alkyl or benzyl, each of which is substituted by m identical or different radicals from the group consisting of halogen, (C₁-C₄)-alkyl and (C₁-C₄)-alkoxy,
R^{p2} represents (C₁-C₄)-alkyl,
R^{p3} represents hydrogen, (C₁-C₄)-alkyl, (C₃-C₈)-cycloalkyl, (C₁-C₄)-alkyl-(C₃-C₈)-cycloalkyl, (C₃-C₆)-halocycloalkyl,
Rⁿ¹ represents (C₁-C₄)-alkyl, (C₃-C₈)-cycloalkyl, (C₁-C₄)-alkyl-(C₃-C₈)-cycloalkyl, (C₃-C₆)-halocycloalkyl,
Rⁿ² represents hydrogen, CO₂(C₁-C₆)-alkyl or S(O)ₙ(C₁-C₆)-alkyl,
W¹ represents (C₁-C₁₀)-alkylene, (C₂-C₆)-alkenylene or (C₂-C₆)-alkynylene,
W² represents (C₁-C₁₀)-alkylene,
R⁶ represents halogen, cyano, hydroxy, amino, nitro, —C(═O)R^{6a}, —C(═O)OR^{6a}, —C(═O)(NR^{6a})₂, —C(═S)NH₂, —C(═O)NHCN, —C(═O)NHOH, —SH, —SO₂(NR^{6a})₂, —SO₂NHCN, —SO₂NHOH, —OCN, —SCN, —SF₅, (C₁-C₆)-alkyl, (C₂-C₆)-alkenyl, (C₂-C₆)-alkynyl, halo-(C₁-C₆)-alkyl, halo-(C₂-C₆)-alkenyl, halo-(C₂-C₆)-alkynyl, (C₃-C₈)-cycloalkyl, halo-(C₃-C₈)-cycloalkyl, (C₁-C₆)-alkyl-(C₃-C₇)-cycloalkyl, (C₃-C₇)-cycloalkyl-(C₁-C₆)-alkyl, (C₃-C₈)-cycloalkenyl, halo-(C₃-C₈)-cycloalkenyl, (C₁-C₆)-alkoxy-(C₁-C₆)-alkyl, (C₃-C₇)-cycloalkoxy-(C₁-C₆)-alkyl, (C₁-C₆)-alkoxy-(C₁-C₆)-alkoxy-(C₁-C₆)-alkyl, (C₁-C₆)-alkylthio-(C₁-C₆)-alkyl, (C₁-C₈)-alkylsulfinyl-(C₁-C₆)-alkyl, (C₁-C₈)-alkoxyhalo-(C₁-C₆)-alkyl, cyano-(C₁-C₆)-alkyl, hydroxy-(C₁-C₆)-alkyl, (C₁-C₆)-alkoxy, halo-(C₁-C₆)-alkoxy, (C₃-C₈)-cycloalkoxy, halo-(C₃-C₈)-cycloalkoxy, (C₃-C₈)-cycloalkyl-(C₁-C₆)-alkoxy, (C₂-C₆)-alkenyloxy, halo-(C₂-C₆)-alkenyloxy, (C₁-C₆)-alkoxy-(C₁-C₆)-alkoxy, (C₂-C₆)-alkylcarbonyloxy, (C₁-C₆)-alkylthio, halo-(C₁-C₆)-alkylthio, (C₃-C₈)-cycloalkylthio, (C₁-C₆)-alkylsulfinyl, halo-(C₁-C₆)-alkylsulfinyl, (C₁-C₆)-alkylsulfonyl, halo-(C₁-C₆)-alkylsulfonyl, (C₃-C₈)-cycloalkylsulfonyl, (C₁-C₆)-alkylamino, di-(C₁-C₆)-alkylamino, halo-(C₁-C₆)-alkylamino, halodi-(C₁-C₈)-alkylamino or (C₃-C₈)-cycloalkylamino, or two vicinal R³ radicals together with the two carbon atoms to which they are attached form a 5- to 7-membered ring which contains v carbon atoms and p identical or different atoms from the group of oxygen, sulfur and nitrogen, and carries t oxo groups,
R^{6a} represents hydrogen, (C₁-C₆)-alkyl, (C₂-C₆)-alkenyl, (C₂-C₆)-alkynyl, (C₃-C₆)-cycloalkyl, (C₃-C₆)-cycloalkyl-(C₁-C₆)-alkyl or phenyl,
R⁷ represents (C₁-C₄)-alkyl, or phenyl substituted by p radicals from the group of halogen, nitro, cyano, (C₁-C₄)-alkyl, (C₁-C₄)-haloalkyl, (C₁-C₄)-alkoxy and (C₁-C₄)-haloalkoxy,
n represents 0, 1 or 2,
p represents 0, 1, 2, 3 or 4,
s represents 0, 1, 2, 3, 4 or 5,
t represents 0, 1, 2, 3 or 4,
v represents 2, 3, 4, 5, 6 or 7,
and
(B) one or more safeners.

2. The herbicide safener composition as claimed in claim 1, in which
X represents halogen, (C₁-C₆)-alkyl, (C₁-C₆)-haloalkyl, (C₂-C₆)-alkenyl, (C₃-C₆)-cycloalkyl, (C₃-C₆)-halocycloalkyl, OR¹, S(O)ₙR², SO₂N(R¹)₂, NR¹SO₂R², NR¹COR¹, (C₁-C₆)-alkyl-S(O)ₙR² or (C₁-C₆)-alkyl-OR¹,
Z represents O,
W represents hydrogen, F, Cl, MeO, methyl or ethyl,
R¹ represents (C₁-C₁₀)-alkyl, (C₂-C₁₀)-alkenyl, (C₂-C₁₀)-alkynyl, halo-(C₁-C₁₀)-alkyl, halo-(C₂-C₁₀)-alkenyl, halo-(C₂-C₁₀)-alkynyl, (C₃-C₁₀)-cycloalkyl, halo-(C₃-C₁₀)-cycloalkyl, (C₁-C₄)-alkyl-(C₃-C₇)-cycloalkyl, (C₃-C₇)-cycloalkyl-(C₁-C₆)-alkyl, (C₁-C₆)-alkoxy-(C₁-C₆)-alkyl, (C₁-C₆)-alkyl-(C₃-C₇)-cycloalkyl, (C₁-C₆)-alkylthio-(C₁-C₆)-alkyl, (C₁-C₆)-alkylsulfinyl-(C₁-C₆)-alkyl, (C₁-C₆)-alkylsulfonyl-(C₁-C₆)-alkyl, cyano-(C₁-C₆)-alkyl, (C₁-C₁₀)-alkoxy, halo-(C₁-C₁₀)-alkoxy, (C₁-C₆)-alkoxy-(C₁-C₆)-alkoxy, (C₁-C₆)-alkylamino or di-(C₁-C₆)-alkylamino,
R¹ represents phenyl carrying s substituents R⁶,
R² represents (C₁-C₄)-alkyl,
Q represents a radical Q⁵, Q⁶, Q⁷ or Q⁸, 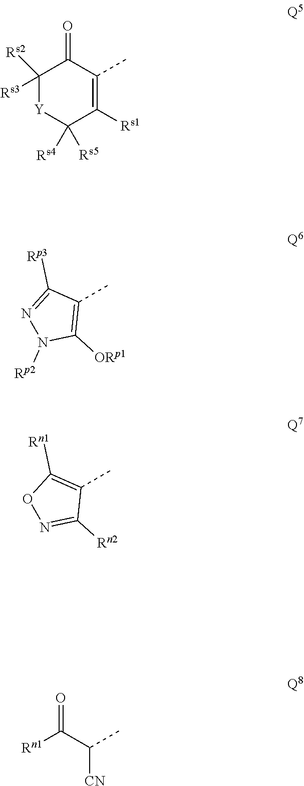
R³ represents (C₁-C₈)-alkyl, (C₂-C₈)-alkenyl, (C₂-C₈)-alkynyl, where these radicals in each case by s radicals from the group consisting of halogen, cyano, nitro, S(O)ₙ—(C₁-C₆)-alkyl, (C₁-C₆)-alkoxy, halo-(C₁-C₆)-alkoxy or (C₃-C₆)-cycloalkyl,
R⁴ represents (C₁-C₆)-alkyl, (C₃-C₇)-cycloalkyl, halo-(C₁-C₆)-alkyl, (C₁-C₆)-alkoxy, halo-(C₁-C₆)-alkoxy, cyano, nitro, methylsulfenyl, methylsulfinyl, methylsulfonyl, (C₁-C₄)-alkylcarbonylamino, benzoylamino, methoxycarbonyl, ethoxycarbonyl, benzoyl, phenoxy, methylcarbonyl, trifluoromethylcarbonyl, halogen, amino, aminocarbonyl, methylaminocarbonyl, dimethylaminocarbonyl or methoxymethyl, or represents phenyl substituted by p radicals from the group consisting of methyl, ethyl, methoxy, trifluoromethyl and halogen,
R⁵ represents hydrogen, (C₁-C₆)-alkyl, (C₃-C₇)-cycloalkyl, halo-(C₁-C₆)-alkyl, (C₃-C₇)-cycloalkylmethyl, methoxycarbonylmethyl, ethoxycarbonylmethyl, acetylmethyl, methoxymethyl, methoxyethyl, benzyl or dimethylamino,
R⁶ represents halogen, cyano, hydroxy, amino, nitro, —C(═O)R^{6a}, —C(═O)OR^{6a}, —C(═O)(NR^{6a})₂, —C(═S)NH₂, —C(═O)NHCN, —C(═O)NHOH, —SH, —SO₂NH₂, —SO₂NHCN, —SO₂NHOH, —OCN, —SCN, —SF₅, (C₁-C₆)-alkyl, (C₂-C₆)-alkenyl, (C₂-C₆)-alkynyl, halo-(C₁-C₆)-alkyl, halo-(C₂-C₆)-alkenyl, halo-(C₂-C₆)-alkynyl, (C₃-C₈)-cycloalkyl, halo-(C₃-C₈)-cycloalkyl, (C₁-C₆)-alkyl-(C₃-C₇)-cycloalkyl, (C₃-C₇)-cycloalkyl-(C₁-C₆)-alkyl, (C₃-C₈)-cycloalkenyl, halo-(C₃-C₈)-cycloalkenyl, (C₁-C₆)-alkoxy-(C₁-C₆)-alkyl, (C₃-C₇)-cycloalkoxy-(C₁-C₆)-alkyl, (C₁-C₆)-alkoxy-(C₁-C₆)-alkoxy-(C₁-C₆)-alkyl, (C₁-C₆)-alkylthio-(C₁-C₆)-alkyl, (C₁-C₈)-alkylsulfinyl-(C₁-C₆)-alkyl, (C₁-C₈)-alkoxyhalo-(C₁-C₆)-alkyl, cyano-(C₁-C₆)-alkyl, hydroxy-(C₁-C₆)-alkyl, (C₁-C₆)-alkoxy, halo-(C₁-C₆)-alkoxy, (C₃-C₈)-cycloalkoxy, halo-(C₃-C₈)-cycloalkoxy, (C₃-C₈)-cycloalkyl-(C₁-C₆)-alkoxy, (C₂-C₆)-alkenyloxy, halo-(C₂-C₆)-alkenyloxy, (C₁-C₆)-alkoxy-(C₁-C₆)-alkoxy, (C₂-C₆)-alkylcarbonyloxy, (C₁-C₆)-alkylthio, halo-(C₁-C₆)-alkylthio, (C₃-C₈)-cycloalkylthio, (C₁-C₆)-alkylsulfinyl, halo-(C₁-C₆)-alkylsulfinyl, (C₁-C₆)-alkylsulfonyl, halo-(C₁-C₆)-alkylsulfonyl, (C₃-C₈)-cycloalkylsulfonyl, (C₁-C₈)-alkylamino, di-(C₁-C₆)-alkylamino, halo-(C₁-C₆)-alkylamino, halodi-(C₁-C₈)-alkylamino, (C₃-C₈)-cycloalkylamino or methylenedioxo,
R^{6a} represents hydrogen or (C₁-C₆)-alkyl,
Y represents O, CO or CR^{s6}R^{s7},
R^{s1} represents hydroxy,
R^{s2} and R^{s5} independently of one another each represent hydrogen or methyl, or
R^{s2} and R^{s5} together form an ethylene or vinylene group,
R^{s3}, R^{s4}, R^{s6} and R^{s7} independently of one another each represent hydrogen or methyl,
R^{p1} represents hydrogen,
R^{p2} represents (C₁-C₄)-alkyl,
R^{p3} represents hydrogen, (C₁-C₄)-alkyl or cyclopropyl,
Rⁿ¹ represents cyclopropyl,
Rⁿ² represents hydrogen,
n represents 0, 1 or 2,
P represents 0, 1, 2, 3 or 4,
s represents 0, 1, 2, 3, 4 or 5.

3. The herbicide safener composition as claimed in claim 1, comprising, as safener B), mefenpyr-diethyl, fenchlorazole, isoxadifen-ethyl, cloquintocet-mexyl, dichlormid, 3-dichloroacetyl-2,2,5-trimethyl-1,3-oxazolidine, benoxacor, 3-dichloroacetyl-1-oxa-3-azaspiro[4.5]decane, 1-dichloroacetylazepane, furilazole, ((R)-3-dichloroacetyl-5-(2-fury))-2,2-dimethyloxazolidine), cyprosulfamide, N-isopropyl-4-sulfamoylbenzamide-1-(2-methoxyphenyl)ethanone, 1-[4-(N-2-methoxybenzoylsulfamoyl)phenyl]-3-methylurea, oxabetrinil, fluxofenim, cyometrinil, 1,8-naphthalenedicarboxylic anhydride, fenclorim, flurazole, dietholate, dimepiperate, daimuron or cumyluron.

4. The herbicide safener composition as claimed in claim 1, comprising, as safener B), daimuron, benoxacor, furilazole, fluxofenim, fenchlorazole (ethyl ester), mefenpyr-diethyl, cloquintocet-mexyl, isoxadifen-ethyl, cyprosulfamide, flurazole, oxabetrinil, dichlormid or dietholate.

5. The herbicide safener composition as claimed in claim 1, comprising, as safener B), mefenpyr-diethyl, isoxadifen-ethyl, cyprosulfamide, fenchlorazole ethyl ester, benoxacor, cloquintocet-mexyl, fluxofenim or furilazole.

6. The herbicide safener composition as claimed in claim 1, comprising, as herbicide A), a compound of formula (I) and/or salt
in which
Q represents Q¹, Q², Q⁴ or Q⁵,
R¹ represents 2-methylphenyl, 2-methoxyphenyl or 2-trifluoromethylphenyl,
R² represents methyl,
R³ represents methyl,
X represents methyl,
W represents hydrogen,
Y represents CR^{s6}R^{s7},
R^{s1} represents hydroxy,
R^{s2} represents hydrogen,
R^{s3} represents hydrogen,
R^{s4} represents hydrogen,
R^{s5} represents hydrogen,
R^{s6} represents hydrogen or methyl,
R^{s7} represents hydrogen or methyl,
and comprising, as safener B), mefenpyr-diethyl, fenchlorazole (ethyl ester), isoxadifen-ethyl, cloquintocet-mexyl, benoxacor, furilazole, cyprosulfamide, fluxofenim or 1-[4-(N-2-methoxybenzoylsulfamoyl)phenyl]-3-methylurea.

7. A method for controlling one or more harmful plants in crops of useful plants, comprising applying a herbicidally active amount of a composition as claimed in claim 1 to the harmful plants, plants, plant seeds and/or an area on which plants grow.

8. The method as claimed in claim 7, wherein the useful plants are selected from the group consisting of sugar cane, corn, wheat, rye, barley, oats, rice, sorghum, cotton and soya.

9. The method as claimed in claim 7, wherein the useful plants have been genetically modified.
